(19) United States
(12) Patent Application Publication
(10) Pub. No.: US 2025/0094848 A1
(43) Pub. Date: Mar. 20, 2025

(54) Quantum Computing Systems and Methods for Quantum Computation

(71) Applicant: Quantinuum Ltd., London (GB)

(72) Inventors: Gabriel Francis Greene Diniz, London (GB); David Zsolt Manrique, London (GB)

(73) Assignee: Quantinuum Ltd., London (GB)

(21) Appl. No.: 18/638,024

(22) Filed: Apr. 17, 2024

(30) Foreign Application Priority Data
Sep. 15, 2023 (GB) 2314159.1

(51) Int. Cl. G06N 10/20

(52) U.S. Cl. CPC G06N 10/20

(57) ABSTRACT

Provided are computer-implemented quantum computation methods and systems that can be used to compute a Green's function, such as for finite-sized fermionic Hubbard models and related impurity models within Dynamical Mean Field Theory. The methods are suitable for implementation using a hybrid classical-quantum computation system. The Green's function is an important quantity for describing optical and electronic responses in quantum systems, from which various properties and behaviours can be computed. Described is a quantum computational method that involves a cumulant expansion of expectation values calculated for each of a set of moments of an operator. This reduces the need for a large overhead in the number of measurements and instead measures the expectation value of the moments with one set of measurement circuits. From the measured moments, a tridiagonal matrix can be computed, which in turn yields the Green's function.

### CROSS-REFERENCE TO RELATED APPLICATIONS

This application claims priority to patent application GB 2314159.1, filed in the United Kingdom on 15 Sep. 2023. The entire contents of that application are incorporated by reference herein.

### FIELD

This specification relates to methods and systems for calculating and analysing physical properties of quantum systems, using a quantum computer or emulated quantum computer to perform computations.

### BACKGROUND

Quantum computers are inherently suitable for determining properties of complex physical systems, by modelling the energy states of individual molecules or solid materials, because they exploit quantum phenomena. Unlike classical digital computers in which the basic unit of computation, the bit, has to be in one of two discrete binary states (1 or 0), quantum computers utilise qubits (2-dimensional objects) or qudits (d-dimensional objects, for d>2) which may exist in a superposition of different computational states. This allows a quantum computer to investigate many different states in parallel. However, quantum computers are vulnerable to stochastic noise which may lead to decoherence between the different quantum states. This noise problem becomes more significant as the number of qubits and gates increase for more complex computational processing.

There is interest in developing computational procedures and implementations of quantum computers for simulating and evaluating the physical properties of materials, such as energy levels and particle interactions. There is also interest in emulating quantum computing systems to simulate and evaluate quantum computation techniques using classical digital computers.

### SUMMARY OF DISCLOSED EMBODIMENTS

Provided are computer-implemented methods and computer systems for use when analysing physical properties of quantum systems, such as optical and electronic properties and behaviours including quantum state changes. The described methods and systems are useful, for example, when simulating a molecular system-which may be an individual molecule or a solid material.

A first computer-implemented quantum computation method comprises:
providing a representation of a physical quantum system as an input to a quantum computation system, the representation of the physical quantum system including at least one operator to perform a function with respect to a quantum state of the physical quantum system;
generating a plurality of quantum circuits from the representation of the physical quantum system, which quantum circuits are adapted to calculate expectation values for a series of moments of at least one operator;
executing the plurality of quantum circuits to calculate expectation values for the series of moments of the at least one operator; and
using cumulant expansion, calculating a Green's Function from the calculated values for the series of moments to determine one or more properties of the physical quantum system.

The series of moments of an operator in this context are the functions of the operator raised to different powers (corresponding to the number of times the operator is applied to a quantum state) and provide information about the properties and dynamic behaviours of the system described. The expectation values of the moments are calculated with respect to a particular state of the quantum system.

The input representation of the physical system is preferably provided as a computer-readable expression including one or more operators representing the dynamic response behaviour of the physical quantum system when manipulated by the operators, such as defining a relationship between an external perturbation or internal interaction and the system's response. For example, a Hamiltonian representation of the energy of a physical quantum system may be provided as an input to a quantum computation system for implementing embodiments of the concepts, techniques, and structures disclosed herein. For example, the Hamiltonian or other input representation may be provided as an input from a separate computer system or from a storage device. A ground state or other reference state of the quantum system may also be an input. The method disclosed herein can be applied to different physical systems using input representations of those physical systems that include different excitation (and annihilation or ‘de-excitation’) operators relating to the dynamic response behaviour of the respective physical system.

The methods described herein may be implemented in a hybrid classical-quantum computer system, including a classical (digital) computing apparatus that generates one or more measurable quantum circuits for each of a plurality of moments of the Hamiltonian or other operator, and a quantum computing apparatus that executes the quantum circuits on its qubits or qudits and outputs measurement results indicating changes to the quantum states of the physical quantum system. Allocation of appropriate tasks to each of a classical binary digital computer and a coupled quantum computer allows exploitation of the respective capabilities of each. This can provide significant advantages when the quantum circuits are executed on resource-constrained noisy intermediate-scale quantum (NISQ) computers, if using the method as described below.

The methods and systems described below enable analysis of the properties and behaviours of real-world physical quantum systems, using computer-readable expressions to describe those properties and behaviours, and generating quantum circuits for each of a set of moments of a functional operator that can cause state changes within the physical system. A cumulant expansion for calculated expectation values for the set of moments, which expectation values are obtained from execution of the quantum circuits, allows calculation of Green's Functions using a hybrid classical-quantum computation system including a NISQ computing apparatus.

The types of operators represented by a Hamiltonian typically include those that govern the dynamic behaviour of a physical quantum system, for example including terms representing kinetic energy, particle interactions, spin interactions, coupling to magnetic fields and other physical properties. In an example implementation, measured expectation values for each of the moments of the Hamiltonian operator (obtained by measuring the results of execution of the quantum circuits on the quantum computing apparatus) provide information about the average behaviour of the physical quantum system that was represented by the Hamiltonian. A set of cumulants are then generated. These cumulants are quantities derived from the measured expectation values for the moments, providing a quantification of properties of the excited states of the quantum system. This use of cumulants helps to analyse the dynamical behaviour of the quantum system. A cumulant expansion method is used to generate elements of a matrix that can be processed on the classical computer. One or more Green's Functions are then computed from the matrix that is generated from the cumulants.

A quantum system responds to disturbances via the responses of its excited states (which are frequency-dependent, and therefore time-dependent), and Green's Functions can be used to analyse those responses. Green's Functions can be used to calculate physical and dynamic properties and behaviours such as:
the effects of particle and spin interactions within the system,
distribution of excited states, for investigating transitions between states as a function of frequency of the time-dependent perturbation,
response functions for analysing the effects of external perturbations and correlations between the applied perturbation and the system response.
   These measured behaviours can provide information about spectroscopic properties (photon emission, photon absorption) of molecules, energy levels, lifetimes of quantum states and conductivity. In Dynamical Mean Field Theory (DMFT), Green's Functions describing electronic properties of materials can be used to provide information about particle interactions and propagation within a material, for example describing the behaviour of electrons at a single lattice site of an isolated impurity and using this to approximate electronic properties within a solid material.

Therefore, Green's Functions can be useful to determine the behaviour and evolution of the quantum system as a simulation that avoids the high cost of synthesizing a new material. This is highly advantageous for cost-efficient materials development and in the use of simulation to enable optimised design of a physical system, and for many industrial applications that require an understanding of the quantum behaviour of a physical system.

In an example method, a quantum computer is used to compute expectation values for eigenvalues and eigenvectors for each of a plurality of moments of a Hamiltonian operator applied to an initial quantum energy state, and then to output a set of cumulants derived from the calculated expectation values for each of the moments. In an example method, the cumulant expansion is followed by assembling the cumulants of the measured expectation values as elements of a matrix. The matrix can then be used to calculate a Green's Function. In an example, the cumulants provide the elements of a tridiagonal matrix that can be processed with computational efficiency. The elements of the matrix may comprise cumulants representing approximations to energy levels and eigenvectors of the system derived from an approximate diagonalization of the system Hamiltonian. The tridiagonal matrix is then used to calculate the Green's function, from which various properties such as frequency-dependent responses to perturbations can be computed.

It is known that the Green's Function can be used to calculate properties and behaviours of a quantum system. However, calculation of the Green's function is also known to be computationally expensive, especially as the size of the quantum system of interest scales up (which is useful for solving large quantum many-body systems that are intractable for classical computers). This is a problem as typical NISQ devices are limited in terms of the hardware resources. Previous quantum computing methods that calculate the Green's function, such as the variational quantum eigensolver (VQE) or quantum subspace expansion (QSE), suffer from these limitations of NISQ devices. This is because their methods result in either a large overhead in terms of the number of measurements or require large amounts of resources. Hence, these approaches are prohibitive for NISQ devices, especially in terms of their circuit depth scaling.

Therefore, there is a need for a method that is suitable for computing the Green's functions on NISQ devices, which mitigates the problems and limitations outlined above. The generation of a plurality of quantum circuits that are each adapted to determine expectation values for moments of the Hamiltonian operator and other required operators, which then provide the elements of a tridiagonal matrix that can be processed on a classical digital computing apparatus, provides a solution for calculation of a Green's function that is well adapted to run on a hybrid system combining a classical computing apparatus with a quantum computing apparatus such as a NISQ computer.

Described below are quantum computation methods that are adapted to represent and calculate physical properties of quantum systems, such as quantum energy levels and quantum states and electronic and spectroscopic properties, using the limited resources of near-term intermediate-scale (NISQ) computers and classical digital computers. Methods described herein can control quantum circuit depth by using a plurality of quantum circuits to compute expectation values for individual moments of a Hamiltonian or other operator. The expectation values are calculated from the results of execution of the quantum circuits and using cumulant expansion of a truncated tridiagonal matrix representation of the Hamiltonian operator, or other operators, which matrix is constructed from the expectation values of the moments. The truncated tridiagonal matrix representation is obtained without explicit diagonalization of Hamiltonian or other operators, and the reduced-dimension matrix is used to calculate a Green's Function that can determine properties such as ground state energy estimates.

A number of different methods are described below for preparing an initial quantum energy state, such as the ground state, of the physical quantum system to be analysed. A state preparation circuit is described for providing an initial state and the outputs of the quantum circuits can be measured for a set of moments with respect to this initial state. Alternatively, we can perform measurements of the outputs of the quantum circuits for each moment of an operator with respect to the ground state provided as an input to the quantum computation system.

Also described below are quantum computation systems and computer program products for implementing the described methods.

A first quantum computation system is a hybrid quantum-classical system comprising:
(i) a classical digital computing apparatus that is configured to receive an input representation of a physical quantum system, the representation of the physical quantum system including at least one operator to perform a function with respect to a quantum state of the physical quantum system, and to generate a plurality of quantum circuits from the representation of the physical quantum system, which quantum circuits are adapted to calculate expectation values for a series of moments of at least one operator; and
(ii) a quantum computing apparatus, coupled to the classical digital computing apparatus, which quantum computing apparatus is configured to execute the plurality of quantum circuits on its qubits or qudits to calculate expectation values for the series of moments of the at least one operator.

The hybrid quantum computation system is also configured to perform, preferably on the classical computing apparatus, a cumulant expansion based on the calculated expectation values for the series of moments, to calculate a Green's Function to determine one or more properties of the physical quantum system.

### BRIEF DESCRIPTION OF THE FIGURES

Example methods and systems are described below, by way of example, with reference to the following Figures:

FIG. 1 shows an example quantum circuit representation of a double qubit excitation operator.

FIG. 2 shows an example parameterised circuit for e^{iθ}^{₁}^{Y}^{₀}^{X}^{₂}e^{iθ}^{₂}^{Y}^{₀}^{X}^{₁}^{X}^{₂}^{X}^{₃}|Ψ_{ref} [symbol] used to obtain the ground state of the Hubbard dimer, with an optimized 2-body qubit excitation.

FIGS. 3 to 8 show simulations of a quantum computed Green's Function (GF) for the Hubbard dimer.

FIG. 9 shows the spectral function of the 4-site Hubbard model when |U/t|=2.

FIGS. 10-13 show results obtained from a classical emulation of a quantum computer.

FIGS. 14-19 show the number of Pauli strings in sandwiched moment operators (for diagonal and off-diagonal elements) versus Hamiltonian moment index n, using 4, 6, and 8 qubits, for non-interacting U=0 (FIGS. 14,16,18) and interacting |U/t|=2 Hubbard models (FIGS. 15,17,19).

FIG. 20 shows the quantum computed GF obtained from the Quantinuum H1-1 trapped ion quantum computer.

FIG. 21 shows the quantum computed GF obtained from the classical emulator of the H1-1 trapped ion quantum computer, with a noise model calibrated to current hardware data.

FIG. 22 shows the quantum computed impurity GF, in which the H1-1 trapped ion quantum computer is used to compute the impurity GF at the final DMFT iteration, following classical impurity GF computations for the previous iterations.

FIG. 23 shows the quantum computed impurity GF after 20 DMFT iterations, in which the emulator of the H1-1 trapped ion quantum computer is used to compute the impurity GF at each iteration.

FIGS. 24-26 show results for an example quantum computed impurity GF of DMFT with 1 impurity and 2 bath sites, in which the H1-1 trapped ion quantum computer is used to compute the impurity GF at the final DMFT iteration, following classical impurity GF computations for the previous iterations.

FIG. 27 shows results for an example quantum computed impurity GF corresponding to 3 bath sites, calculated to full convergence of the DMFT algorithm. Hamiltonian moment expectation values correspond to ideal noiseless calculations, yielding a corresponding noiseless GF.

FIG. 28 is a schematic representation of a hybrid quantum-classical computer system in which embodiments of the concepts, techniques, and structures disclosed herein may be implemented, including classical computer 110 and quantum computer 210.

FIG. 29 is a schematic representation of a method according to embodiments of the concepts, techniques, and structures disclosed herein.

### DETAILED DESCRIPTION OF EMBODIMENTS

Described are methods and systems for computation using a quantum computer, including methods and systems configured for computation of Green's Functions describing the behaviour of quantum systems, such as optical and electronic responses. In an example implementation, which is described below, one or more measurable quantum circuits is provided for each of a plurality of moments of an operator, such as an excitation operator of an input Hamiltonian. A cumulant expansion of the elements of the tridiagonal Hamiltonian matrix in terms of calculated expectation values, obtained from measuring the execution results of the quantum circuits for each of these moments, provides a set of cumulants that are suitable for building the Green's Function. This can be implemented by applying the known Lanczos method, or a similar method for assembly of cumulants, to the measured results of execution of the quantum circuits for the individual moments, with respect to an initial quantum state (e.g. taking an initial Lanczos vector, and repeatedly applying a quantum operator to the initial vector to give a sequence of vectors). The measurable expectation values can be used to derive cumulants that are assembled as elements of a tridiagonal Hamiltonian matrix (e.g. the Lanczos coefficients), without explicitly diagonalizing a complete matrix. From this tridiagonal matrix, a continued fraction expression of the Green's Function can be evaluated, providing information about the behaviour of the quantum system.

The cumulant expansion of the Lanczos coefficients enables at least two strategies for implementation in a quantum algorithm: i) prepare an initial Lanczos vector explicitly with a state preparation circuit and measure the moments as expectations with respect to this circuit, or ii) measure each moment as the expectation value of an operator built by sandwiching Ĥⁿ with ladder operators (or sums of ladder operators) indexed according to the initial Lanczos vector.

Described below is an example quantum computational method to calculate elements of a matrix representing the single particle Green's function in a spin orbital basis—i.e. using the spin orbitals that describe quantum states of an electron in an atom or molecule or other quantum system. Electrons may have both spin and spatial degrees of freedom. The approach involves a cumulant expansion of the Lanczos method, using Hamiltonian moments as measurable expectation values and providing measurable quantum circuits for each moment of a Hamiltonian. This avoids the need for a large overhead in the number of measurements (avoiding repeated applications of the variational quantum eigensolver (VQE)), and instead measures the expectation value of the moments with one set of measurement circuits. The cumulants are values derived from the measured expectation values for the moments, providing a quantification of dynamical properties of the quantum system. These cumulants can approximately account for independent fluctuations of, and correlations between, responses of excited states of the system. Cumulants can be expressed as a relation between higher-order moments and lower-order moments. For example, a second cumulant known as the variance can be calculated as the second moment minus the square of the first moment. Higher order cumulants can capture more complex correlations and fluctuations.

### 1 Introduction

The Lanczos method can be used in quantum computing to approximate the eigenvalues and eigenvectors of an operator whose representation would be a large matrix. The method described below is used to construct a sparse tridiagonal matrix that is smaller in dimension than the original matrix would have been. This tridiagonal matrix is then used to obtain the approximate eigenvalues and eigenvectors of the original matrix. The Lanczos method is useful for finding a subset of eigenvalues and eigenvectors of large matrices without explicitly computing all of them, which would be computationally expensive.

The Green's function (GF) provides a way to describe and quantify dynamic electronic responses of a physical system to external perturbations and internal particle and spin interactions and is useful for calculating physical properties including spectroscopic properties, such as photoemission and photoabsorption, and conductivity. It can also be used to capture electronic correlations in condensed matter and quantum chemical simulations. In addition, calculating the GF is central to many quantum embedding methods such as Dynamical Mean Field Theory (DMFT). Despite its importance in these fields, the GF remains a difficult quantity to calculate from first principles on classical computers.

This disclosure describes efficient computation of the Lanczos coefficients and enables efficient calculation of the Green's Function.

In a previous study, an approach based on the Lanczos method was proposed to obtain the GF on quantum computers. This approach relies on a parameterised VQE method to construct the Krylov space, hence the orthonormal Lanczos basis is calculated iteratively in which a VQE-like algorithm is applied at each Lanczos iteration. This involves an overhead in the number of measurements and renders the approach more susceptible (relative to a typical ground state calculation) to the potential difficulties associated with variational optimization (such as barren plateaus). This is also the case for a recent proposal based on variational compilation. A method based on quantum subspace expansion (QSE) has also been proposed, in which the Hamiltonian and overlap matrix elements are obtained in a basis for the ground state and in another basis for the Krylov states involved in the GF. The basis sets are prepared using time evolution, and the matrix elements are subsequently measured on a quantum computer. The Krylov basis and Lanczos coefficients are then calculated iteratively on a classical computer. While an interesting approach, we note that QSE requires more resources than VQE, and the reliance on Trotterized time evolution may lead to a vulnerability to Trotter errors as a function of the time step. We also note the approach of Kosugi and Matsushita in which (multi-) controlled operations between ancillas, and state qubits are used to represent the ladder operators involved in the (off-) diagonal elements of the GF matrix, with a subsequent application of quantum phase estimation (QPE). Other recently proposed methods obtain the GF using an algorithm to sample a Fourier series expansion or using a 3-qubit iTofolli gate. Such approaches are prohibitive for the noisy intermediate-scale quantum (NISQ) era in terms of circuit depth scaling. A recent approach also considers low energy expansions of the Green's Function for a simplified form of DMFT, which does not require calculating the full Green's Function.

As mentioned above, the Green's Function is an important quantity in quantum embedding methods such as DMFT. In recent years, a number of quantum computational approaches to DMFT have been published. These works involve simplifications which increase tractability, yet decrease generalisability, such as a restriction to two sites via the single Anderson impurity model (SIAM). In this picture, the quasiparticle weight has an analytical form, to which the updated impurity-bath interaction is related in a simple way, by appealing to the limit of infinite dimensions. Previous works have also measured the Green's Function in the time-domain to solve the impurity model in DMFT, which can lead to a large overhead in the number of measurements per time step, or a reliance on fault tolerant schemes such as QPE, or the use of a simplified sinusoidal form of the Green's Function, or other techniques. We also note that one approach has been recently used to obtain the impurity Green's Function for the DMFT solution of the Hubbard-Holstein model.

This disclosure describes methods and systems that provide advantages over the above-described previous works to provide a quantum computed Green's Function that can be utilized in a hybrid quantum-classical algorithm that is appropriate for NISQ systems, in order to solve for the Green's function of a full system, or for an embedded system as in DMFT.

In the methods and systems described below, a cumulant expansion of the Lanczos coefficients is utilized together with measurable quantum circuits for each moment of the Hamiltonian. These measurable expectation values can be used to calculate the elements of the tridiagonalised Hamiltonian matrix in the Krylov basis, from which the continued fraction expression of the GF can be evaluated. Thus, we extend the prior art, among other ways, by utilizing quantum computed moments to develop a quantum computational method for calculating the full GF matrix.

As a first example, a method according to embodiments of the concepts, techniques, and structures disclosed herein has been applied to the calculation of the GF of the fermionic Hubbard model. We note that there have been recent studies of the ground state properties of the Hubbard model using quantum algorithms. Rather than investigating efficient ways to find the ground state, an example method described in this disclosure instead focusses on a quantum approach to calculate GFs for finite chains of Hubbard sites. In addition, this approach can be applied to DMFT in a straight-forward manner to iteratively calculate the quantum computed impurity GF to self-consistency, as shown below. The described methodology is suitable for implementation in quantum computation software products such as the INQUANTO quantum computational chemistry package that is available from Quantinuum Ltd. of London, England. The software can be implemented and executed using a quantum computer such as one of the trapped ion quantum computers available from Quantinuum.

Our results show that application of this approach to the Quantinuum H1-1 trapped ion quantum computer results in spectral features (derived from the imaginary part of the GF) that compare well with ideal classical simulations, particularly in terms of peak positions, even without error mitigation techniques. Hence, expectation values of Hamiltonian moments are relatively robust to measurement noise for low lying Lanczos roots, which is consistent with previous applications of the method to infimum estimates of the ground state energy. The stability of this method also extends to iterative calculations of the impurity GF in the DMFT algorithm, even when circuit-based measurements or emulated circuit-based measurements are used to evaluate the Hamiltonian moments at every DMFT iteration.

The detailed description below is organised as follows. In section 2 we describe the methods and show how the quantum computed moments can be used to obtain the GF. This is followed by a brief overview of DMFT applied to the Bethe lattice with multiple bath sites. In section 3, we present our results. Starting with the Hubbard model, we show that our method can be applied to multiple sites and benchmark our results against the classical Lanczos method. We then demonstrate this method on quantum hardware. Following this, we utilize the quantum computed GF in a DMFT algorithm. Section 4 provides some concluding remarks.

### 2 Methods

### 2.1 Quantum Computed Moments for Green's Functions

In this section, we give a brief overview of a method involving a cumulant expansion applicable to the Lanczos method, and its application to computing the GF in a quantum computational setting. The Lanczos recursion method can be viewed as an approximate diagonalisation scheme, resulting in a tridiagonal form of the Hamiltonian matrix which can be efficiently solved. In a typical classical Lanczos routine, the elements of the tridiagonalised matrix (referred to as Lanczos coefficients below) αₗ= [symbol] νₗ|Ĥ|νₗ [symbol] and βₗ= [symbol] νₗ₊₁|Ĥ|νₗ [symbol] = [symbol] νₗ|Ĥ|νₗ₊₁ [symbol] are used to numerically orthonormalise the Lanczos vectors

$$\vert {v}_{l + 1} 〉 = \frac{( \hat{H} - {α}_{l} ) \vert {v}_{l} 〉 - {β}_{l} \vert {v}_{l - 1} 〉}{{β}_{l + 1}} ,$$

where l=1,2,3 and β₀=0.

This scheme can be re-expressed for a quantum computational context. The Lanczos coefficients can be expressed with the moments of the Hamiltonian operator Ĥ with respect to some initial Lanczos vector, [symbol] Ĥⁿ [symbol] = [symbol] ν₁|Ĥⁿ|ν₁ [symbol] . Therefore, a quantum algorithm that can compute the moments and these can be used to generate the Lanczos coefficients. For example, for the upper 2×2 block of the tridiagonal matrix (i.e. α₁, α₂, β₁), the quantities obtained from a quantum algorithm are the expectations values [symbol] Ĥ [symbol] , [symbol] Ĥ² [symbol] , and [symbol] Ĥ³ [symbol] , and the coefficients are calculated as:

$${α}_{1} = 〈 \overline{H} 〉 \qquad ( 1 )$$

$${β}_{1} = \sqrt{〈 {\hat{H}}^{2} 〉 - {〈 \hat{H} 〉}^{2}}$$

$${α}_{2} = \frac{〈 {\hat{H}}^{3} 〉 - 2 〈 \hat{H} 〉 〈 {\hat{H}}^{2} 〉 + {〈 \hat{H} 〉}^{3}}{〈 {\hat{H}}^{2} 〉 - {〈 \hat{H} 〉}^{2}} .$$

In general, it can be shown that the Lanczos coefficients α₁ and β₁ can be expressed as functions of { [symbol] Ĥⁿ [symbol] }_{n=1.2l-1} and explicit expressions can be obtained via a cumulant expansion of the Lanczos coefficients.

Once the Lanczos coefficients are obtained, they can be used to calculate the zero temperature GF matrix in the continued fraction representation. In this representation, the diagonal elements of the single particle GF take the following form when decomposed into particle and hole parts:

$$\begin{matrix}{G}_{ii}^{L} ( ω ) = {g}_{ii}^{( p )} ( ω ) + {g}_{ii}^{( h )} ( ω ) \\ = \frac{{n}_{ii}^{( p )}}{ω + {E}_{GS} - {α}_{1}^{( p )} - \frac{{β}_{1}^{( p )}}{ω + {E}_{GS} - {α}_{2}^{( p )}} - ⋯} \\ + \frac{{n}_{ii}^{( h )}}{ω - {E}_{GS} + {α}_{1}^{( h )} - \frac{{β}_{1}^{( h )}}{ω - {E}_{GS} + {α}_{2}^{( h )}} - ⋯} ,\end{matrix} \qquad ( 2 )$$

where E_{GS} is the ground state energy, and the numerators are related to normalised states obtained by operating on the ground state with the fermionic creation (\hat{f}ᵢ^{†}) and annihilation (\hat{f}ᵢ) operators, applied to spin orbital (or qubit) i (Jordan-Wigner encoding is assumed throughout this disclosure). These normalised states correspond precisely to the initial Lanczos vector for each diagonal GF element. Using the particle component gᵢᵢ^{(p)}(ω) as an example, we can write

$$\vert {v}_{1} 〉 ≡ \vert {Ψ}_{ii}^{( p )} 〉 = \frac{{\hat{f}}_{i}^{†} \vert {Ψ}_{GS} 〉}{\sqrt{{n}_{ii}^{( p )}}} , \qquad ( 3 )$$

where nᵢᵢ^{(p)}= [symbol] Ψ_{GS}|\hat{f}ᵢ\hat{f}ᵢ^{†}|Ψ_{GS} [symbol] , and |Ψ_{GS} [symbol] is the ground state represented by a quantum circuit. In Eq. 2 the Lanczos coefficients αₗ^{(p/h)}, βₗ^{(p/h)} are labelled by their particle/hole contributions, according to whether the initial Lanczos vector is obtained by operating on |Ψ_{GS} [symbol] with \hat{f}ᵢ^{†} (p) or with \hat{f}ᵢ (h).

The off-diagonal elements are obtained in an analogous way using linear combinations of fermionic operators indexed by the matrix element. For example, this results in an initial Lanczos vector for g_{i≠j}^{(p)} (ω)

$$\vert {Ψ}_{i \neq j}^{( p )} 〉 = \frac{( {\hat{f}}_{i}^{†} + {\hat{f}}_{j}^{†} ) \vert {Ψ}_{GS} 〉}{\sqrt{{n}_{i \neq j}^{( p )}}} , \qquad ( 4 )$$

where n_{i≠j}^{(p)}= [symbol] Ψ_{GS}|(\hat{f}ᵢ+\hat{f}ᵢ)(\hat{f}ᵢ^{†}+\hat{f}ᵢ^{†})|Ψ_{GS} [symbol] . Following through as above, the resulting off-diagonal element G_{i≠j}^{L} (ω) then requires a correction, which has a simple arithmetic form. Utilizing the symmetry of the GF matrix, we finally obtain the GF off-diagonal element as

$${G}_{i \neq j} ( ω ) = \frac{1}{2} ( {G}_{i \neq j}^{L} ( ω ) - {G}_{ii} ( ω ) - {G}_{jj} ( ω ) ) , \qquad ( 5 )$$

with Gᵢᵢ(ω)=Gᵢᵢ^{L}(ω).
   Thus, a method for quantum computation of the full GF matrix is obtained, without the explicit reliance on multicontrolled ancilla qubits, time evolution, or phase estimation. On the other hand, relative to methods involving explicit time-evolution or phase estimation, this approach in general requires a larger number of measurements, hence we recognize a trade-off between circuit depth and number of measurements when choosing between these approaches. We also note that this method does not require calling a VQE routine for each Lanczos root, nor a time-evolved subspace expansion to obtain the Lanczos basis vectors.

In practical terms, the cumulant expansion of the Lanczos coefficients combined with the continued fraction representation of Gᵢⱼ(ω) enables at least two strategies for implementation in a quantum algorithm: i) prepare the initial Lanczos vector explicitly with a state preparation circuit and measure the moments as expectations with respect to this circuit, or ii) measure each moment as the expectation value of an operator built by sandwiching Ĥⁿ with ladder operators (or sums of ladder operators) indexed according to the initial Lanczos vector. Ladder operators are creation and annihilation operators.

As an example, consider the n^{th} moment contributing to a Lanczos coefficient required for gᵢᵢ^{(p)}(ω). Using i) we would prepare |Ψᵢᵢ^{(p)} [symbol] and measure

$$〈 {\hat{H}}_{ii}^{n , ( p )} 〉 = 〈 {Ψ}_{ii}^{( p )} \vert {\hat{H}}^{n} \vert {Ψ}_{ii}^{( p )} 〉 . \qquad ( 6 )$$

Using ii) we would prepare |Ψ_{GS} [symbol] and measure

$$〈 {\hat{H}}_{ii}^{n , ( p )} 〉 = ( 1 / {n}_{ii}^{( p )} ) 〈 {Ψ}_{GS} \vert \hat{{f}_{i}} {\hat{H}}^{n} {\hat{{f}_{i}}}^{†} \vert {Ψ}_{GS} 〉 . \qquad ( 7 )$$

Thus, these described example implementations of the method involve either |Ψᵢᵢ^{(p)} [symbol] or |Ψ_{GS} [symbol] being prepared on a quantum circuit, in addition to the measurement of Hamiltonian moments. While mathematically equivalent, i) and ii) can lead to considerable differences in the quantum circuit resources (depending on the state preparation methods) and catering for both approaches allows for a useful flexibility in the application of the quantum Lanczos approach to GFs. As is known, a naive counting of Hamiltonian terms results in an exponential growth in the number of Pauli strings with Hamiltonian power n. However, this can be significantly improved by the existence of large commuting sets in the H moment expansions. To mitigate the rapid growth, we measured the commuting Pauli terms with a single measurement circuit. However, we note there are other efficient techniques that could be also applied based on the tensor product basis (TPB) and qubit-wise commutativity.

The following paragraphs provide further details on strategies i) and ii) for executing the quantum Lanczos approach to calculate a GF, followed by an outline of how the ground state can be prepared.

### i) Initial Lanczos Vector Preparation

In the occupation number (ON) vector representation, the ground state is expressed as

$$\vert {Ψ}_{GS} 〉 = {\sum }_{x} {c}_{x} \vert x 〉 , \qquad ( 8 )$$

where x={xᵢ} represents a set of occupations of spin orbitals i for a given number of particles, and each basis configuration can be written as the ON vector of Nᵢ spin orbitals

$$\vert x 〉 = \vert {x}_{0} , {x}_{1} , … , {x}_{i} , … , {x}_{{N}_{i} - 1} 〉 . \qquad ( 9 )$$

Given a circuit representing the ground state, the coefficients of the ON vector (Eq. 8) can then be extracted by calculating the overlap

$${c}_{x} = 〈 x \vert {Ψ}_{GS} 〉 = 〈 x \vert {\hat{U}}_{GS} ( {θ}_{opt} ) \vert {Ψ}_{0} 〉 \qquad ( 10 )$$

for all x, resulting in a set of cₓ values, and the corresponding {|x [symbol] }, hence the ON representation (Eq. 8) is obtained. The ON representation of |ν₁ [symbol] ≡|Ψᵢᵢ^{(p)} [symbol] or |ν₁ [symbol] ≡|Ψᵢᵢ^{(h)} [symbol] is then obtained by applying \hat{f}ᵢ^{†} or \hat{f}ᵢ, respectively, to Eq. 8 and normalising (as in Eq. 3). The resulting expansion of |ν₁ [symbol] as a linear combination of basis configurations with real coefficients can then be prepared on a quantum circuit using controlled Givens rotations as particle-conserving excitations. While the procedure defined by Eqs. 8-10 in general exhibits an exponentially scaling overhead (due to the inclusion of all particle-number preserving configurations) for the representation of |ν₁ [symbol] to be exact, it is used here to demonstrate the flexibility of our procedure to allow for arbitrary preparation of the initial Lanczos vector. Hence future preparation schemes with better scaling can be easily accommodated.

### ii) Sandwiched Moment Expectation

As mentioned above, one can measure the Hamiltonian moment as the expectation with respect to the ground state of a sandwiched Hamiltonian moment operator, see equation 7. This requires the preparation of a quantum circuit representing the ground state, which can be achieved by a VQE-optimized variational ansatz. Following the JW transformation of \hat{f}ᵢĤⁿ\hat{f}ᵢ^{†} (and of \hat{f}ᵢ^{†}Ĥⁿ\hat{f}ᵢ for the hole part), the corresponding Pauli strings can then be measured with respect to the ground state circuit. In section 3.1.2, we report Pauli operators representing the measurable sandwiched Hamiltonian moments for GF elements of the Hubbard dimer for Lanczos coefficients corresponding to l=2.

### Ground State Preparation

To prepare the ground state, a number of approaches have been proposed in recent years based on hybrid quantum-classical algorithms such as imaginary time evolution, or VQE. These approaches generally involve the application of a unitary Û_{GS} to a reference state |Ψ₀ [symbol] , where Û_{GS}(θ) is expressed as an ansatz which depends on parameters θ that are variationally optimized to θₒₚₜ. For the latter, a wide range of chemically intuitive (e.g. Unitary Coupled-Cluster, “UCC”) and hardware efficient ansätze have been proposed. In addition, adaptive methods also exist in which the ansatz is constructed iteratively for a given problem. Disclosed herein is a quantum approach to the Green's Function, which could rely on an assumption that an accurate ground state has been provided from a separate calculation. In an example practical implementation, the ground state circuit was prepared with a VQE algorithm with a parameterised ansatz, but the approach also supports the classical calculation of the ground state (which would exemplify a procedure that combines classical computing for ground state properties, with quantum computing for excited state properties), as long as the classical calculation yields an expansion of the state vector in a basis of occupation configurations, since the latter in principle can always be prepared using controlled excitation gates, as outlined for strategy i).

### 2.2 Fermionic Hubbard Model

In an example demonstrating the disclosed approach, we quantum compute the Green's Function of the fermionic Hubbard model, the Hamiltonian of which can be written as

$$\begin{matrix}{\hat{H}}_{Hub} = - μ {\sum }_{s} {\sum }_{σ} {\hat{f}}_{s , σ}^{†} {\hat{f}}_{s , σ} \\ - t {\sum }_{< r , s >} {\sum }_{σ} ( {\hat{f}}_{r , σ}^{†} {\hat{f}}_{s , σ} + {\hat{f}}_{s , σ}^{†} {\hat{f}}_{r , σ} ) \\ + U {\sum }_{s} {\hat{f}}_{s , ↑}^{†} {\hat{f}}_{s , ↑} {\hat{f}}_{s , ↓}^{†} {\hat{f}}_{s , ↓} ,\end{matrix} \qquad ( 11 )$$

where μ, t, and U are the chemical potential, hopping amplitude, and on-site Coulomb interaction, respectively (t=1 in these calculations, which sets the energy scale throughout this specification). s labels a site, <r,s> denotes nearest neighbor pairs of sites, and spins are labelled by σ=↑, ↓. To establish consistency with the spin orbital index i of the Green's Function matrix (see section 2.1), we use a linear mapping between the site-spin index and the spin orbital index s, ↑(s, ↓)→i(i+1) where s=0,1,2, . . . , Nₛ−1 and i=2s, hence G_{sσ s′σ′}≡Gᵢⱼ. There are Nₛ×1×1 Hubbard sites arranged in a linear geometry.

Since we use Jordan-Wigner (JW) encoding throughout, the spin orbital index i also corresponds to a qubit index on a quantum circuit. Fermionic operators are mapped according to JW encoding as

$${\hat{{f}_{i}}}^{†} ↦ \frac{{X}_{i} - {iY}_{i}}{2} {\prod }_{d = 0}^{i - 1} {Z}_{d} \qquad ( 12 )$$

$$\hat{{f}_{i}} ↦ \frac{{X}_{i} + {iY}_{i}}{2} {\prod }_{d = 0}^{i - 1} {Z}_{d}$$

where i²=−1 (referring to the non-italic symbol i), and Pᵢ∈{Iᵢ, Xᵢ, Yᵢ, Zᵢ} refers to a Pauli rotation gate applied to qubit i. This results in a qubit representation of the Hamiltonian as a sum of tensor products of Pauli operators.

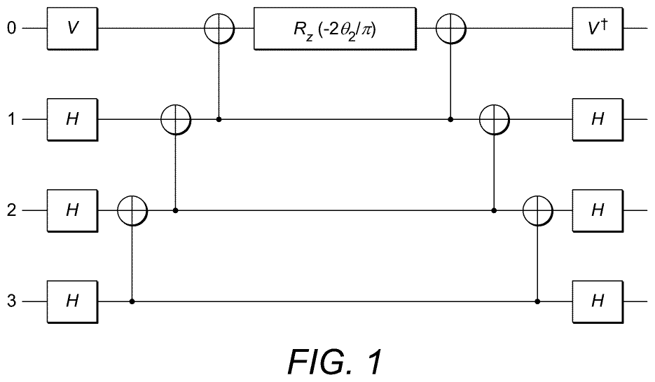

Given the qubit representation of Ĥ_{Hub}, the corresponding GF Gᵢⱼ^{Hub} is then obtained using the methodology outlined in section 2.1. We assume the half-filled regime (μ=−U/2), set the initial reference state to the half-filled singlet configuration, and obtain the ground state using VQE with a parameterized ansatz. For the latter, we utilize qubit excitations in the Hard-core Boson representation to obtain the ground state using significantly fewer 2-qubit gates than Unitary Coupled Cluster. Consider the Hubbard dimer, corresponding to 4 qubits. The initial reference state of a spin-up electron occupying site 0 and a spin-down on site 1 (|Ψ_{ref} [symbol] =|1001 [symbol] ) can be prepared with Pauli-X gates. The ground state can then be obtained by applying two qubit excitation operators, i.e. unitary operators corresponding to a single-excitation and a double-excitation which act directly on the qubit Hilbert space (hence obviating the need for Pauli-Z gates to maintain fermionic exchange antisymmetry |Ψ_{GS}(θ₁, θ₂) [symbol] =e^{iθ}^{₁}^{Y}^{₀}^{X}^{₂}e^{iθ}^{₂}^{Y}^{₀}^{X}^{₁}^{X}^{₂}^{X}^{₃}|Ψ_{ref} [symbol] . The double excitation portion of this circuit is shown in FIG. 1, which is an example quantum circuit representation of a double qubit excitation operator e^{iθ}^{₂}^{Y}^{₀}^{X}^{₁}^{X}^{₂}^{X}^{₃}. The V, V^{†}, and H gates are for rotation into the desired computational basis, while the CNOTs and R_{z} represent the exponentiated Pauli strings corresponding to the qubit excitation.

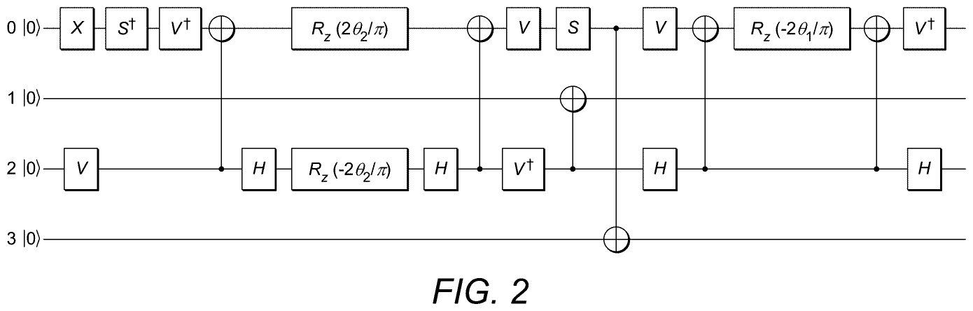

By utilizing particle-hole symmetry, as well as total spin symmetry (equal number of spin-↑ and spin-↓ electrons at half-filling), the number of 2-qubit gates for the double-excitation can be reduced as follows: step 1) treat the double-excitation initially as a single-excitation involving Pauli operators acting on two Hubbard sites instead of four spin orbitals (equivalent to using the molecular spatial orbital index in a chemically aware strategy), step 2) specify the qubit excitation between sites as the excitation between qubits representing the same spin on either site (e.g. for a spin-↑ to spin-↑ excitation in the Hubbard dimer, this corresponds to a qubit excitation involving qubits 0 and 2), step 3) reintroduce spin orbital indexing by applying 2-qubit CNOTs which pair the relevant even-odd indexed qubits. The net result is a series of gates which perform the equivalent action of the double-excitation unitary e^{iθ}^{₂}^{Y}^{₀}^{X}^{₁}^{X}^{₂}^{X}^{₃} but with fewer CNOTs. This replaces the double-excitation circuit in FIG. 1. Due to spin symmetry and the lack of (s, ↑)→(r, ↓) cross-spin hopping between sites s and r≠s, only one single-excitation unitary is needed. The resulting ansatz circuit is shown in FIG. 2. We also note that all measurable circuits in this work can be compiled for some chosen hardware using the architecture-agnostic quantum software compiler T|KET> that is available from Quantinuum.

FIG. 2 shows an example parameterised circuit for e^{iθ}^{₁}^{Y}^{₀}^{X}^{₂}e^{iθ}^{₂}^{Y}^{₀}^{X}^{₁}^{X}^{₂}^{X}^{₃}|Ψ_{ref} [symbol] used to obtain the ground state of the Hubbard dimer, with an optimized 2-body qubit excitation. The X gate on qubit 0 corresponds to Hubbard site 0 occupied by an even-indexed electron. The S, S^{†}, V, V^{†}, and H gates are for rotation into the desired computational basis. The CNOTs with qubit 0 (2) as targets (controls) bracketing the R_{z} represent the exponentiated Pauli strings corresponding to the qubit excitations. The 3^{rd} and 4^{th} CNOTs translate the action of previous gates to odd-indexed qubits, resulting in a double excitation e^{iθ}^{₂}^{Y}^{₀}^{X}^{₁}^{X}^{₂}^{X}^{₃} applied to the initial reference state |Ψ_{ref} [symbol] =|1001 [symbol] , followed by the single excitation e^{iθ}^{₁}^{Y}^{₀}^{X}^{₂}.

### 2.3 Dynamical Mean Field Theory

We also apply our approach to quantum compute the impurity Green's Function within the DMFT solution of the single band Hubbard model on a Bethe lattice. In the limit of infinite connectivity, the Green's Function of this model can be interpreted as the impurity-site Green's Function of an Anderson model Hamiltonian

$$\begin{matrix}{\hat{H}}_{And} = {\hat{H}}_{imp} \\ + {\sum }_{b = {N}_{s}}^{{N}_{s} + {N}_{b}} {\sum }_{σ} {ϵ}_{b , σ} {\hat{f}}_{b , σ}^{†} {\hat{f}}_{b , σ} \\ + {\sum }_{b = {N}_{s}}^{{N}_{s} + {N}_{b}} {\sum }_{σ} {V}_{b , σ} ( {\hat{f}}_{σ}^{†} {\hat{f}}_{b , σ} + {\hat{f}}_{b , σ}^{†} {\hat{f}}_{σ} ) ,\end{matrix} \qquad ( 13 )$$

in which N_{b} is a number of bath sites, and Ĥᵢₘₚ=Ĥ_{Hub}(Nₛ=1), and baths sites are indexed by b. ∈_{b,σ} and V_{b,σ} are variational parameters corresponding to the on-site bath energies and impurity-bath interactions, respectively. Here, we set ∈_{b,↑}=∈_{b,↓} and V_{b,↑}=V_{b,↓}. We use the same topology for the Anderson impurity model as Kreula et al.

Solving for the eigenspectrum of Ĥ_{And} yields the GF of the impurity+bath system, the upper 2×2 block of which corresponds to the impurity-site GF, Gᵢⱼ^{imp}. Since there is only 1 impurity site and no spin-flipping terms, impurity-related quantities such as Gᵢⱼ^{imp} are 2×2 diagonals and reduce to scalar functions of frequency in this case, however we write these as matrices in a basis of impurity spin orbitals i, j for consistency in notation and to emphasise, generalisability. We solve for the Gᵢⱼ^{imp} using the methodology of section 2.1.

The dynamical interaction between the impurity and bath is governed by the U=0 GF of the Anderson impurity model of Caffarel et al., the inverse of which is called hybridisation

$${Δ}_{ij} ( i {ω}_{k} ) = ( i {ω}_{k} + μ - {\sum }_{σ} {\sum }_{b}^{{N}_{bath}} \frac{{V}_{b , σ}^{2}}{i {ω}_{k} - {ϵ}_{b , σ}} ) {I}_{ij} , \qquad ( 14 )$$

where Iᵢⱼ is the identity matrix, and iωₖ is the k^{th} Matsubara frequency. The Anderson model can also be related to Gᵢⱼ^{imp} by a self-consistency condition

$${Δ}_{ij}^{sc} ( i {ω}_{k} ) = ( i {ω}_{k} + μ ) {I}_{ij} - \frac{{G}_{ij}^{imp} ( i {ω}_{k} )}{2} . \qquad ( 15 )$$

We note that strict self-consistency can only be obtained for N_{bath}=∞. This limit can be numerically approximated by a finite bath by varying the bath parameters to minimise the cost function

$$C ( \{ {ϵ}_{b , σ} \} , \{ {V}_{b , σ} \} ) = \frac{1}{{N}_{ω} + 1} {\sum }_{k = 1}^{{N}_{ω}} {\vert {Δ}_{ij}^{sc} ( i {ω}_{k} ) - {Δ}_{ij} ( i {ω}_{k} ) \vert}^{2} , \qquad ( 16 )$$

thereby fitting Δᵢⱼ to Δᵢⱼ^{sc}. Here, N_{ω} is the number of fitting frequencies, and we note that all DMFT fitting is performed on a grid of imaginary Matsubara frequencies

$$i {ω}_{k} = \frac{i π ( 2 k + 1 )}{β}$$

where β is an inverse temperature which sets a frequency grid cutoff above iωₖ=0. In our applications, we run the DMFT algorithm on 1, 2, and 3 bath sites, corresponding to 4, 6, and 8 qubits, respectively. For 1 bath site, bath fitting is performed on 26 imaginary frequencies and β=8. While for 2 and 3 bath sites, bath fitting is performed on 64 imaginary frequencies with β=16. Numerical minimisation of C results in a new set of bath parameters {∈_{b,σ}}, {V_{b,σ}}, which in turn define a new Ĥ_{And}, which leads to a new Gᵢⱼ^{imp} via the approach described in section 2.1. Eqs. 13-16 therefore suggest an iterative algorithm, which can be terminated at a threshold value of the convergence error τ. For the latter, we use the absolute change in Δᵢⱼ^{sc} between iterations m and m+1. We assume the half-filled regime, hence μ is set to U/2 which corresponds to 1 electron on the impurity site in the ground state. To find the number of electrons in the bath, the following is performed: after finding the ground state of Ĥ_{And} for a given set of bath parameters, the total number of electrons Nₑ is obtained from the expectation of the total number operator. Bath sites are then filled according to the number of bath electrons=Nₑ−1. The resulting occupation state is then used to construct the initialise the Lanczos procedure to solve for the impurity GF using the approach outlined in section 2.1. This procedure can be summarised by noting that we consider the Anderson impurity model to be in thermodynamic equilibrium with a reservoir of particles, hence it is treated as a grand canonical ensemble with the number of electrons in the Hubbard impurity set by particle-hole symmetry. In order to find the ground state of Ĥ_{And} at each DMFT iteration, the UCC Single and Double (“UCCSD”) ansatz is optimized using the VQE.

### 3 Results

### 3.1 Green's Functions of Hubbard Chains

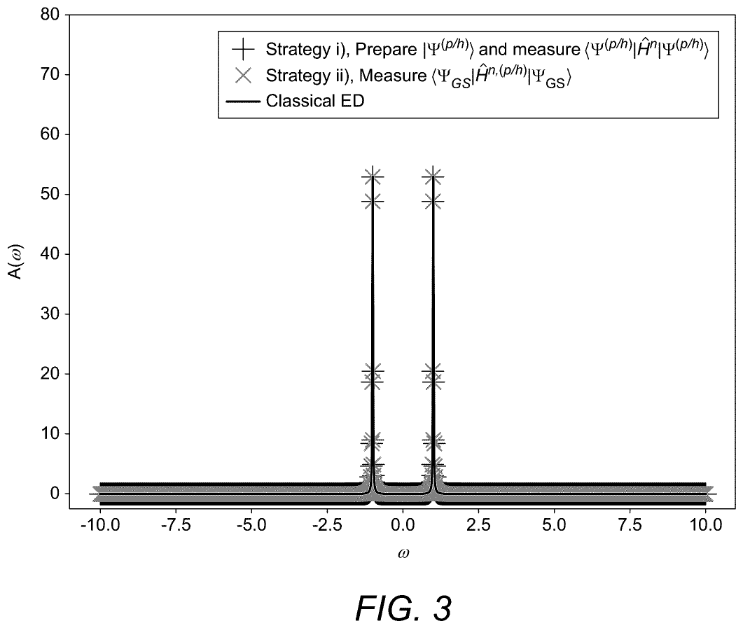

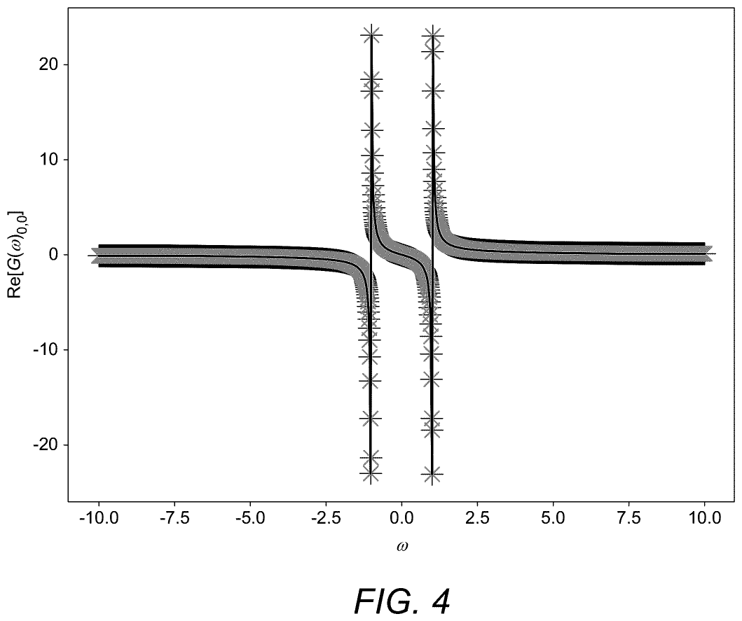

FIGS. 3 to 8 show ideal simulations of quantum computed Green's Function for the Hubbard dimer when U=0 (FIGS. 3-4),

$$\frac{U}{t} = 2$$

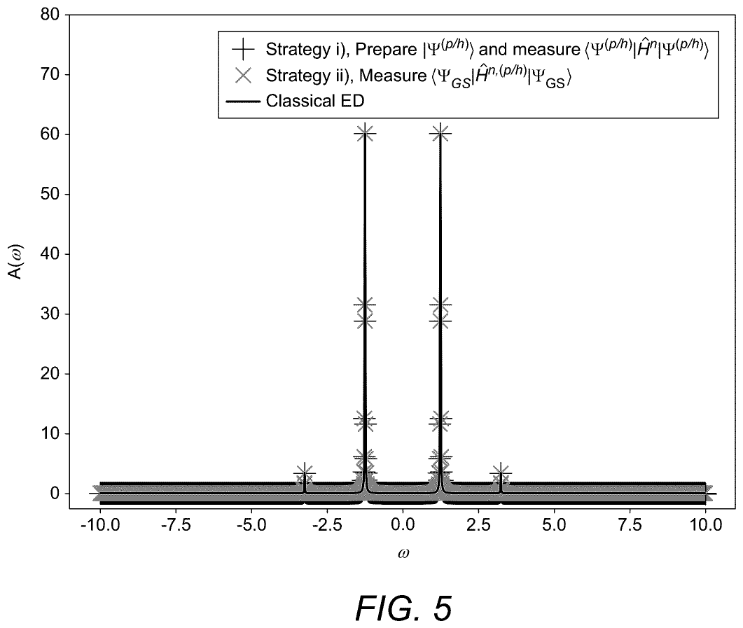

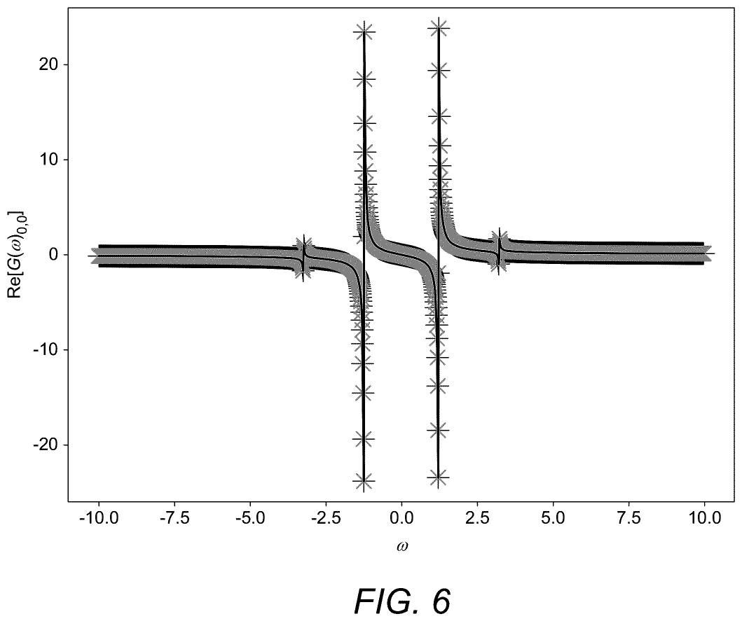

(FIGS. 5-6), and when

$$\frac{U}{t} = 8$$

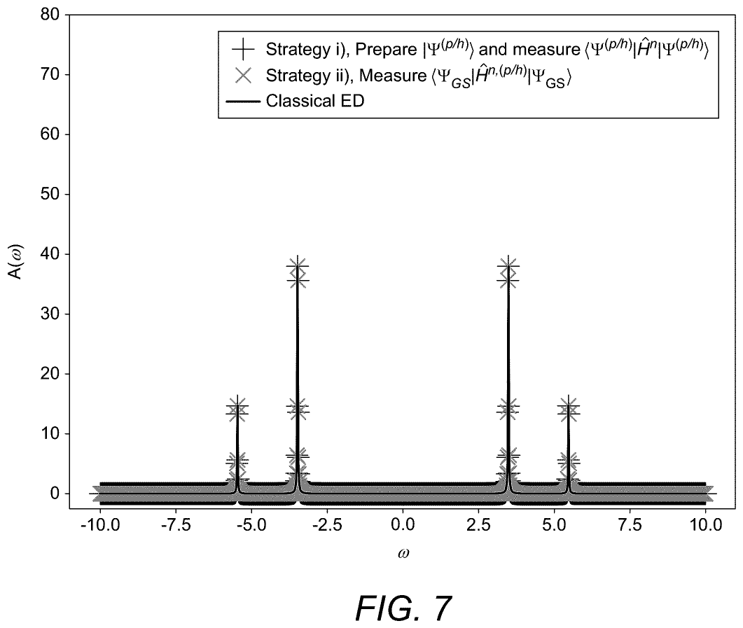

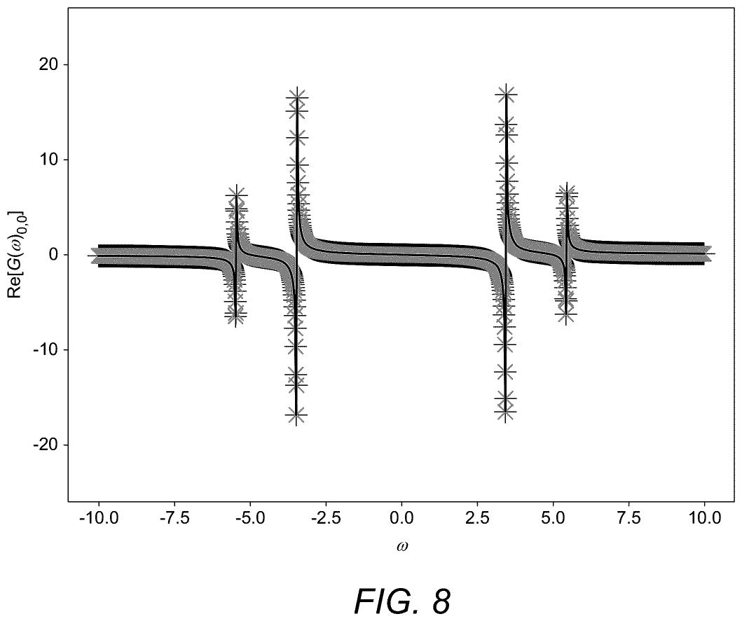

(FIGS. 7-8), using two different initialisation strategies for the quantum Lanczos routine: ‘+’ corresponds to strategy i), while ‘×’ represents strategy ii). In the legend, spin orbital indexes ij have been omitted and Ĥ^{n,(p)}=\hat{f}Ĥⁿ\hat{f}^{†}, Ĥ^{n,(h)}=\hat{f}^{†}Ĥⁿ\hat{f}. FIGS. 3,5,7 show the spectral function, and FIGS. 4,6,8 show the real part of the Goo element for a respective one of FIGS. 3,5,7. We note that in this case the Lanczos routine reproduces the Green's Function (GF) obtained from exact diagonalization (ED).

In FIGS. 3 to 8, we compare a statevector simulated (noiseless) quantum GF to the classically calculated GF (throughout this work, results labelled ‘classical ED’ correspond to the GF in the Lehmann representation at zero temperature, obtained with classical exact diagonalisation), for the non-interacting (U=0), intermediate

$$( \frac{U}{t} = 2 ) ,$$

and strongly correlated

$$( \frac{U}{t} = 8 )$$

regimes of the Hubbard dimer. In FIGS. 3 to 8, the spectral function, and the real part of a diagonal element of the GF, are plotted. The spectral function is obtained from the imaginary part of the diagonal elements of the GF

$$A ( ω ) = - \frac{1}{π} Im Tr [ {G}_{ij} ( ω + i δ ) ] . \qquad ( 17 )$$

where δ is a broadening term, and we set δ=0.01. Both strategies i) and ii) (described in section 2.1) are used in FIGS. 3 to 8, showing their equivalence in terms of physical results. In terms of the circuit resources used in either case, interesting differences arise due to the differences in state preparation and operator expectation measurement. In this case, the exact solution is obtained (i.e. the continued fraction GF matches the GF calculated from exact diagonalisation (ED)) for maximum l=2. This corresponds to a maximum Hamiltonian moment of n=3, as in Eq. 1.

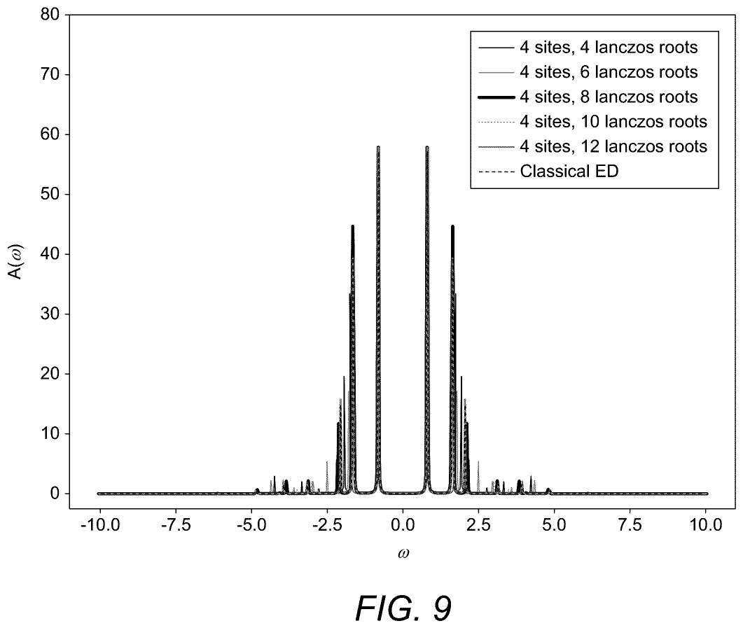

With reference to FIG. 9, the spectral function is calculated for a 4-site Hubbard model, with an increasing number of Lanczos roots (i.e. increasing dimensionality of the Krylov space). FIG. 9 shows the result of calculating the spectral function of the 4-site Hubbard model when

$$\vert \frac{U}{t} \vert = 2 ,$$

using ideal simulations of quantum computed Green's Functions, using strategy ii) for the quantum Lanczos routine. The convergence of the spectral function with respect to the number of Lanczos roots (maximum value of l) is observed. Peak positions are reasonably converged for ≥8 Lanczos roots. Dashed line shows the result from exact diagonalisation. This shows that at 8 Lanczos roots, reasonable accuracy is obtained in the position of spectral peaks (energies which exhibit poles of the GF), with most of the deviation relative to the exact result exhibited in the weights (rather than positions) of the peaks near ω˜±2.

### 3.1.1 Strategy i) Initial Lanczos Vector Preparation: Hubbard Model

Following the noiseless VQE optimization of the ground state ansatz (FIG. 2), the ground state of the interacting Hubbard dimer exhibits the following expansion in terms of ON basis vectors

$$\vert {Ψ}_{G S} 〉 = {c}_{1100} \vert 1100 〉 + {c}_{1001} \vert 1001 〉 + {c}_{0110} \vert 0110 〉 + {c}_{0011} \vert 0011 〉 , \qquad ( 18 )$$

where the coefficients depend on U and t Hubbard parameters, with C₁₁₀₀=C₀₀₁₁, C₁₀₀₁=−C₀₁₁₀ due to symmetry and fermionic exchange, and for the noninteracting U=0,t=1 case, |c₁₁₀₀|=|C₀₀₁₁|=|c₁₀₀₁|=|C₀₁₁₀|=1/2. Taking the diagonal element of the particle and hole GFs g₀₀^{(p)} and g₀₀^{(h)} as an example, which require preparation of Lanczos vectors

$$\vert {Ψ}_{00}^{( p )} 〉 = \frac{{\hat{f}}_{0}^{†} \vert {Ψ}_{G S} 〉}{\sqrt{{n}_{00}^{( p )}}}$$

and

$$\vert {Ψ}_{00}^{( h )} 〉 = \frac{{\hat{f}}_{0} \vert {Ψ}_{G S} 〉}{\sqrt{{n}_{00}^{( h )}}}$$

to measure the [symbol] Ĥᵢᵢ^{n,(p)} [symbol] and [symbol] Ĥᵢᵢ^{n,(h)} [symbol] , respectively, the following expansions for these Lanczos vectors are obtained after applying the ladder operators to the ground state

$$\vert {Ψ}_{00}^{( p )} 〉 = \frac{{c}_{0110}}{\sqrt{{n}_{00}^{( p )}}} \vert 1110 〉 + \frac{{c}_{0011}}{\sqrt{{n}_{00}^{( p )}}} \vert 1011 〉 , \qquad ( 19 )$$

$$\vert {Ψ}_{00}^{( h )} 〉 = \frac{{c}_{1100}}{\sqrt{{n}_{00}^{( h )}}} \vert 0100 〉 + \frac{{c}_{1001}}{\sqrt{{n}_{00}^{( h )}}} \vert 0001 〉 . \qquad ( 20 )$$

The quantum circuits representing Eqs. 19 and 20 (in addition to the off-diagonal terms) can then be prepared using multicontrolled Given's rotations to obtain arbitrary (particle-conserving) linear combinations of basis states. In strategy i), in contrast to strategy ii), we do not measure the expectation of sandwiched moments with respect to the ground state, but rather take the expectation of the moments Ĥⁿ with respect to the Lanczos vectors. Hence, the Pauli strings to be measured for each GF element do not change with the element index of the GF matrix. The Pauli strings take the following form after JW encoding the fermionic Hamiltonian moments

$${\hat{H}}^{1} ↦ \frac{1}{2} ( {Z}_{0} {Z}_{1} + {Z}_{2} {Z}_{3} - {X}_{0} {Z}_{1} {X}_{2} - {Y}_{0} {Z}_{1} {Y}_{2} - {X}_{1} {Z}_{2} {X}_{3} - {Y}_{1} {Z}_{2} {Y}_{3} ) , \qquad ( 21 )$$

$${\hat{H}}^{2} ↦ \frac{1}{2} ( 3 I - {X}_{0} {X}_{1} {Y}_{2} {Y}_{3} + {X}_{0} {Y}_{1} {Y}_{2} {X}_{3} + {Y}_{0} {X}_{1} {X}_{2} {Y}_{3} - {Y}_{0} {Y}_{1} {X}_{2} {X}_{3} + {Z}_{0} {Z}_{1} {Z}_{2} {X}_{3} - {Z}_{0} {Z}_{2} - {Z}_{1} {Z}_{3} ) , \qquad ( 22 )$$

$${\hat{H}}^{3} ↦ \frac{1}{2} ( {X}_{0} {X}_{1} {X}_{2} {X}_{3} + {X}_{0} {Y}_{1} {X}_{2} {Y}_{3} - 3 {X}_{0} {Z}_{1} {X}_{2} + 2 {X}_{0} {X}_{2} {Z}_{3} + {Y}_{0} {X}_{1} {Y}_{2} {X}_{3} + {Y}_{0} {Y}_{1} {Y}_{2} {Y}_{3} - 3 {Y}_{0} {Z}_{1} {Y}_{2} + 2 {Y}_{0} {Y}_{2} {Z}_{3} + 2 {Z}_{0} {X}_{1} {X}_{3} + 2 {Z}_{0} {Y}_{1} {Y}_{3} + 2 {Z}_{0} {Z}_{1} - {Z}_{0} {Z}_{3} - 3 {X}_{1} {Z}_{2} {X}_{3} - 3 {Y}_{1} {Z}_{2} {Y}_{3} - {Z}_{1} {Z}_{2} + 2 {Z}_{2} {Z}_{3} ) . \qquad ( 23 )$$

(with I≡I₀I₁I₂I₃). However, the circuits corresponding to the Lanczos vectors do change with GF matrix element index and grow rapidly with the size of the system. Considering the scaling of the number of terms in Eq. 18 with respect to the number of qubits, the number of terms required to exactly represent the Lanczos vectors (Eqs. 19 and 20) scales exponentially. Hence, the feasibility of strategy i) largely depends on how the Lanczos vectors are prepared on the quantum circuit.

A well-known issue with the Lanczos method is the degradation of the Lanczos basis due to floating point precision. Typically, this degradation occurs for large values of l, where βₗ tends to become small and hence numerical noise is amplified when dividing by βₗ to normalise |νₗ [symbol] . In classical schemes, this is typically treated by re-orthogonalising the current |νₗ [symbol] to the set of previously calculated vectors {|ν_{k<l} [symbol] }. However, quantum noise and the statistical nature of circuit measurements required for the evaluation of Hamiltonian moments can also affect the Lanczos basis and associated Lanczos coefficients calculated from the measured moments.

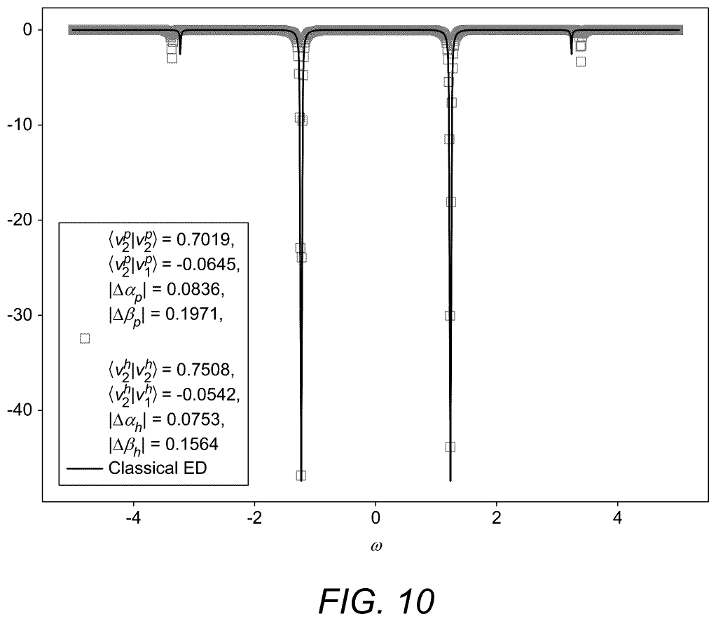

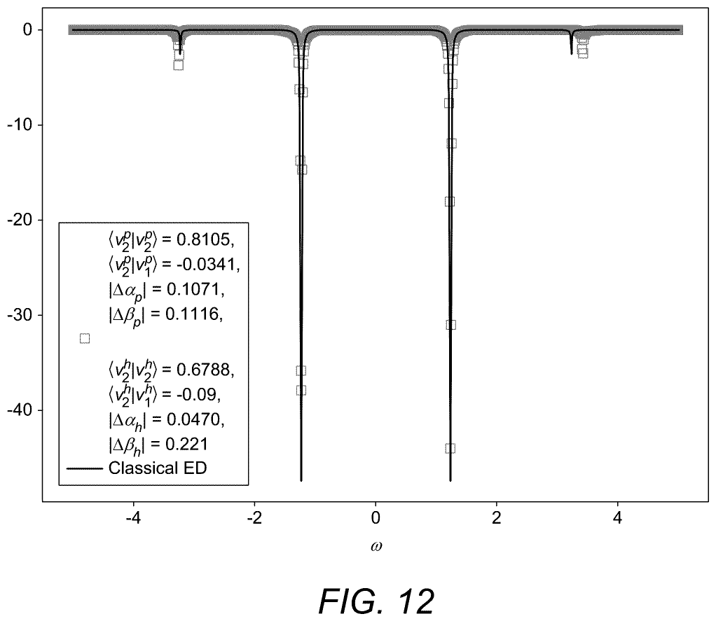

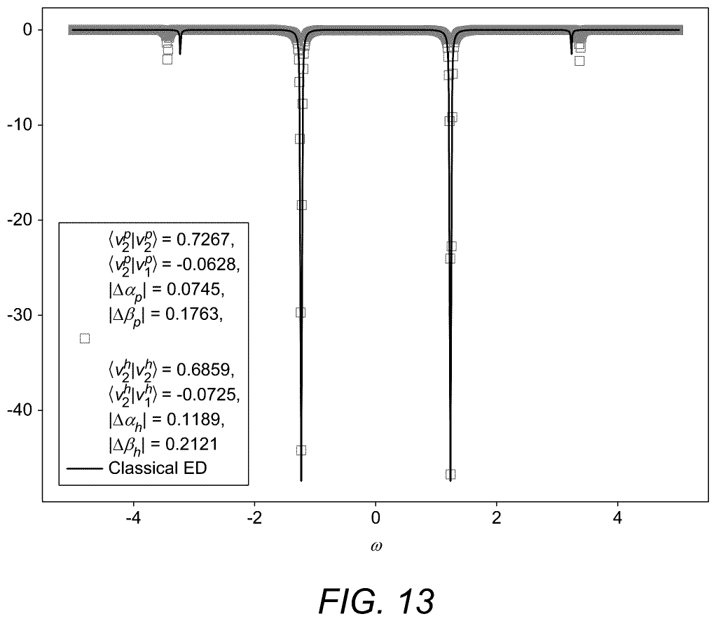

To study this, the imaginary part of a diagonal element of G for the Hubbard dimer is obtained from measurements of expectations of Hamiltonian moments corresponding to the particle (g₀₀^{(p)}) and hole (g₀₀^{(h)}) contributions to G₀₀. The results are obtained from the Quantinuum H1-1 emulator, a classical device emulator with a noise model corresponding to the noise profile of the H1-1 device. These emulated experiments correspond to one of the 14 measurable circuits to be described in section 3.2, representing the upper diagonal elements of the particle and hole GF matrices, both with 23 (7) total (2-qubit) gates and depth 13. These are plotted alongside the normalised absolute errors in αₗ and βₗ resulting from measurements, and the diagonal and off-diagonal components of the overlap matrix elements calculated classically from the Lanczos vectors which in turn are built from the measured αₗ and βₗ. Since the ED result for the Hubbard dimer GF is recovered for maximum l=2, only α₁, α₂, and β₁ are used in this case, and we average the error in αₗ. Hence the errors in the Lanczos coefficients are calculated as

$$\vert {Δα}^{( p / h )} \vert = \frac{1}{2} ( \vert \frac{{α}_{1}^{( p / h )} - {α}_{1 , exact}^{( p / h )}}{{α}_{1 , exact}^{( p / h )}} \vert + \vert \frac{{α}_{2}^{( p / h )} - {α}_{2 , exact}^{( p / h )}}{{α}_{2 , exact}^{( p / h )}} \vert ) \qquad ( 24 )$$

$$\vert {Δβ}^{( p / h )} \vert = ( \vert \frac{{β}_{1}^{( p / h )} - {β}_{1 , exact}^{( p / h )}}{{β}_{1 , exact}^{( p / h )}} \vert ) \qquad ( 25 )$$

where α_{l,exact}^{(p/h)}, β_{l,exact}^{(p/h)} are noiseless ideal values of the Lanczos coefficients. The next Lanczos vector |ν₂ [symbol] is then constructed from these measured Lanczos coefficients, and its norm [symbol] ν₂/ν₂ [symbol] and overlap with ν₁ are obtained classically (since the ground state parameters are obtained from an ideal noise free calculation, and the vector norms are calculated classically, the first Lanczos vector ν₁^{(p/h)}=|Ψ₀₀^{(p/h)} [symbol] has unity norm by construction). The results of 4 separate emulator runs, corresponding to 4 separate sets of measurements, are shown in FIGS. 10-13. In particular, FIGS. 10-13 show the imaginary part of G₀₀(ω) obtained from a classical emulation of the Quantinuum H1-1 computer, from the 4 separate runs. For each run, the associated errors in Lanczos coefficients are shown, along with the norms of the Lanczos vector constructed from the (moment-)measured coefficients. It can be observed that, for a given set of measurements, the error in βₗ resulting from the quantum noise correlates to the deviation from unity norm of ν₂, which is not unexpected since βₗ governs the normalisation of the Lanczos vectors. This error in normalisation also translates to the deviation of spectral peak heights from the exact result, which gives a qualitative understanding of the effect of quantum noise in βₗ on the resulting GF: within each plot of FIGS. 10-13, a larger |Δβ^{(p/h)}| results in a worse relative peak height (compared to ED) for g₀₀^{(p/h)}, where superscript “p” (“h”) denotes contribution to the positive (negative) frequency spectral peaks.

Also, quantum noise at the circuit level can have a cumulative effect on the orthogonalization of the Lanczos vectors at higher roots, the study of which requires measurements of corresponding higher moments of the Hamiltonian with respect to the ground state for models larger than the Hubbard dimer. Such measurements require circuits too deep for the current NISQ era, as errors due to gate infidelities and qubit decoherence would accumulate and dominate the measurements of associated Pauli operators. Hence, we leave the effect of quantum noise on the orthogonalization of Lanczos vectors for higher lying roots as an open question for future studies, although we note the investigation of Vallury et al. into the effect of noise and device errors on the arithmetical operations involved in the assembly of cumulants, in which it was found that infimum estimates of the ground state energy are improved in accuracy and more robust to device noise relative to variational approaches to optimizing [symbol] Ĥ(θ) [symbol] . The relation between numerical errors in the Lanczos basis and quantum noise could have interesting implications for error mitigation, which we briefly discuss in the conclusion.

### 3.1.2 Strategy ii) Sandwiched Moment Expectation: Hubbard Model

Using the particle GF as an example, the first, second, and third powers of the Hamiltonian, sandwiched between ladder operators, and contributing to the diagonal element g₀₀^{(p)}, are mapped to the following sums of Pauli operator strings via JW encoding.

$${\hat{f}}_{0} {\hat{H}}^{1} {\hat{f}}_{0}^{†} ↦ ( - \frac{1}{4} {Z}_{0} {X}_{1} {Z}_{2} {X}_{3} - \frac{1}{4} {Z}_{0} {Y}_{1} {Z}_{2} {Y}_{3} - \frac{1}{4} {Z}_{0} {Z}_{1} + \frac{1}{4} {Z}_{0} {Z}_{2} {Z}_{3} - \frac{1}{4} {X}_{1} {Z}_{2} {X}_{3} - \frac{1}{4} {Y}_{1} {Z}_{2} {Y}_{3} - \frac{1}{4} {Z}_{1} + \frac{1}{4} {Z}_{2} {Z}_{3} ) , \qquad ( 26 )$$

$${\hat{f}}_{0} {\hat{H}}^{2} {\hat{f}}_{0}^{†} ↦ ( \frac{3}{4} I + \frac{3}{4} {Z}_{0} - \frac{1}{4} {Z}_{0} {Z}_{1} {Z}_{2} {Z}_{3} - \frac{1}{4} {Z}_{0} {Z}_{1} {Z}_{3} + \frac{1}{4} {Z}_{0} {Z}_{2} - \frac{1}{4} {Z}_{1} {Z}_{2} {Z}_{3} - \frac{1}{4} {Z}_{1} {Z}_{3} + \frac{1}{4} {Z}_{2} ) , \qquad ( 27 )$$

$${\hat{f}}_{0} {\hat{H}}^{3} {\hat{f}}_{0}^{†} ↦ ( - \frac{3}{4} {Z}_{0} {X}_{1} {Z}_{2} {X}_{3} - \frac{1}{2} {Z}_{0} {X}_{1} {X}_{3} - \frac{3}{4} {Z}_{0} {Y}_{1} {Z}_{2} {Y}_{3} - \frac{1}{2} {Z}_{0} {Y}_{1} {Y}_{3} - \frac{1}{2} {Z}_{0} {Z}_{1} - \frac{1}{4} {Z}_{0} {Z}_{1} {Z}_{2} + \frac{1}{2} {Z}_{0} {Z}_{2} {Z}_{3} + \frac{1}{4} {Z}_{0} {Z}_{3} - \frac{3}{4} {X}_{1} {Z}_{2} {X}_{3} - \frac{1}{2} {X}_{1} {X}_{3} - \frac{3}{4} {Y}_{1} {Z}_{2} {Y}_{3} - \frac{1}{2} {Y}_{1} {Y}_{3} - \frac{1}{2} {Z}_{1} - \frac{1}{4} {Z}_{1} {Z}_{2} + \frac{1}{2} {Z}_{2} {Z}_{3} + \frac{1}{4} {Z}_{3} ) \qquad ( 28 )$$

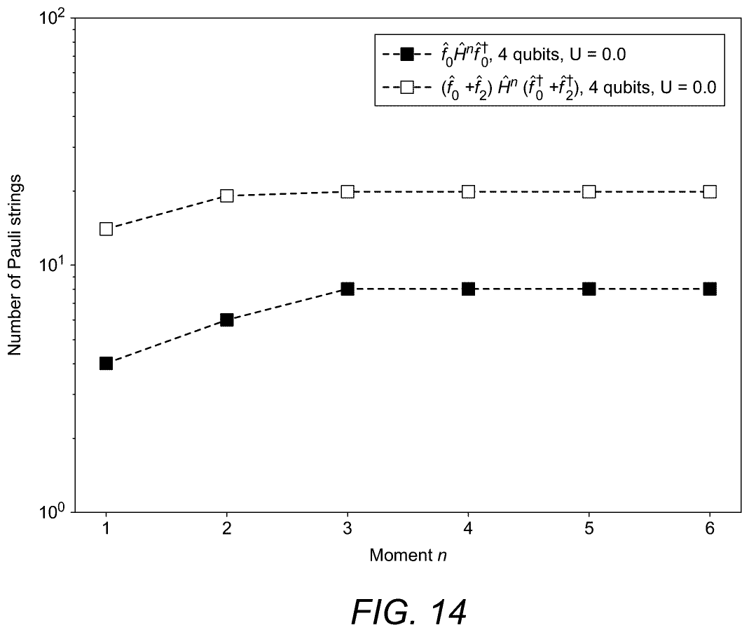

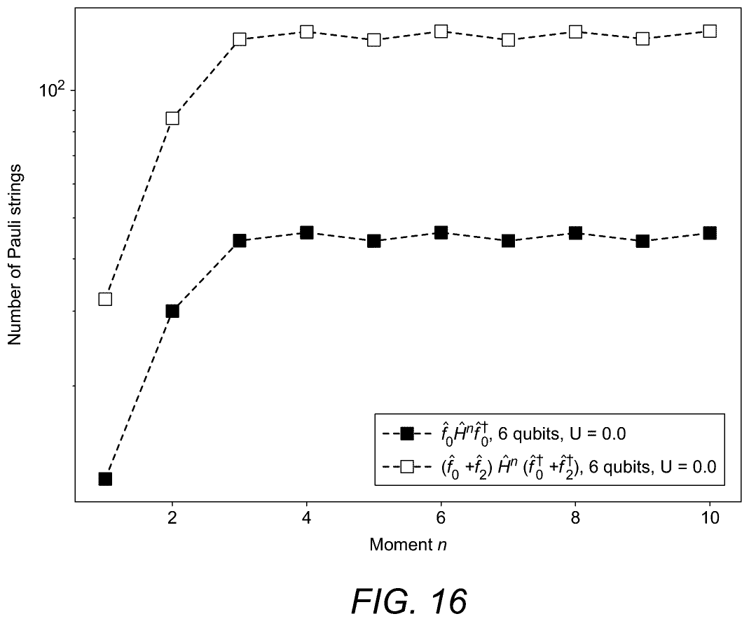

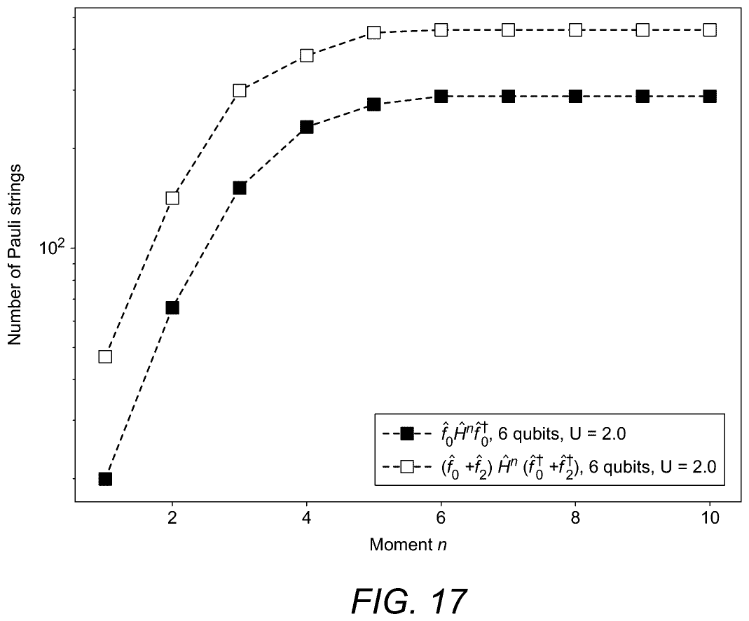

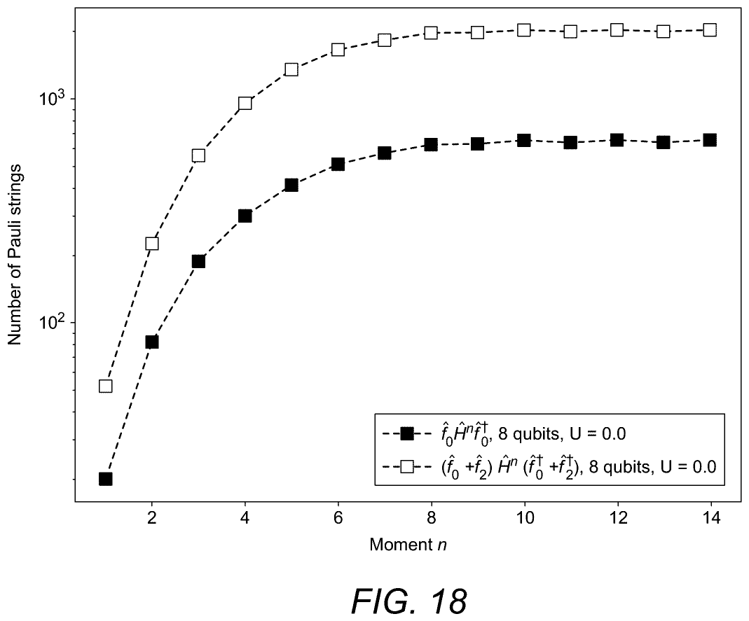

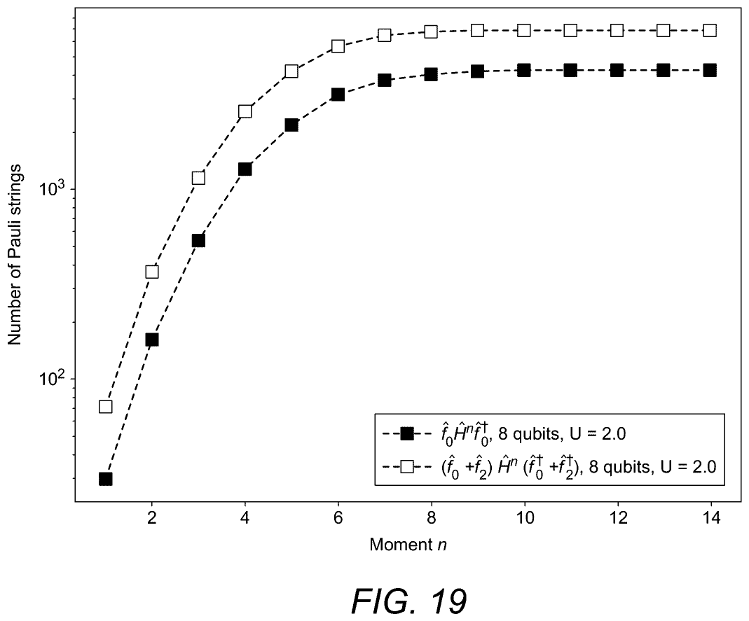

At variance to strategy i), in strategy ii) the measurable Pauli strings contributing to each GF element change with matrix element index. This is exemplified for 2, 3, and 4 Hubbard sites (4, 6, and 8 qubits, respectively) in FIGS. 14-19, in which the number of Pauli strings in \hat{f}₀Ĥⁿ\hat{f}₀^{†}, and in (\hat{f}₀+\hat{f}₂)Ĥⁿ(\hat{f}₀^{†}+\hat{f}₂^{†}) (contributing to the off-diagonal element g₀₂^{(p)}), are plotted as a function of n. In particular, FIGS. 14-19 show the number of Pauli strings in sandwiched moment operators (for diagonal and off-diagonal elements) versus Hamiltonian moment index n, using 4, 6, and 8 qubits, for non-interacting U=0 (FIGS. 14,16,18) and interacting

$$\vert \frac{U}{t} \vert = 2$$

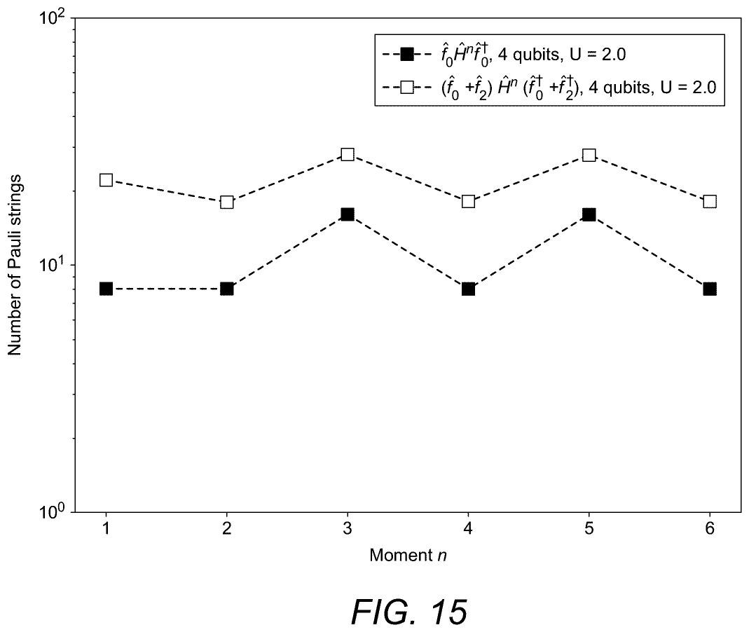

Hubbard models (FIGS. 15,17,19). For an interacting case of 4 qubits, oscillations in the number of Pauli strings are observed for even and odd n; the magnitude of these oscillations rapidly decrease as the system size increases. For larger numbers of qubits, the shape of the curve (semilog plot) is characteristic of polynomial scaling and indicates a roughly convergent number of Pauli strings as a function of n as the Lanczos procedure approaches the full dimensionality of the Hilbert space (or symmetry-reduced subspace thereof).

Interestingly, the total number of individual Pauli terms does not necessarily increase with the Hamiltonian power. This effect manifests in two ways: 1) The concatenation of Pauli strings that occurs when taking the power can result in the collapse of products into smaller equivalent strings; this is evident for smaller numbers of qubits where the number of Pauli strings can oscillate for even and odd powers of Ĥ, however the importance of this decreases rapidly as the system size grows (see FIGS. 14-19). 2) In general, the maximum number of Pauli strings for N qubits is 4^{N}, however the Hamiltonian will have less terms than this (depending on the interactions of the model) for a given N which will affect the number of individual strings that result from n powers of Ĥ; our results show that the number of Pauli strings for the Hubbard Hamiltonian saturates for values of n large enough for the Lanczos procedure to sufficiently cover the Hilbert (sub) space of the model (in general of lower dimensionality of the full Hilbert space of N qubits due to symmetry), which occurs at large enough values of the Lanczos index l defined in section 2.1.

The resulting manageable number of Pauli terms of small models, in addition to the optimized qubit excitation ansatz circuit for the ground state presented in section 2.2 (in this strategy, the circuits corresponding to the bra and ket of [symbol] Ĥᵢᵢ^{n,(p/h)} [symbol] do not change with GF matrix index, unlike strategy i)), facilitate the quantum calculation of the full GF matrix of the Hubbard dimer on Quantinuum's H1 ion-trap machine, the results of which are presented in the next section.

### 3.2 Green's Functions Calculated from Hardware Experiments

### 3.2.1 Hubbard Model

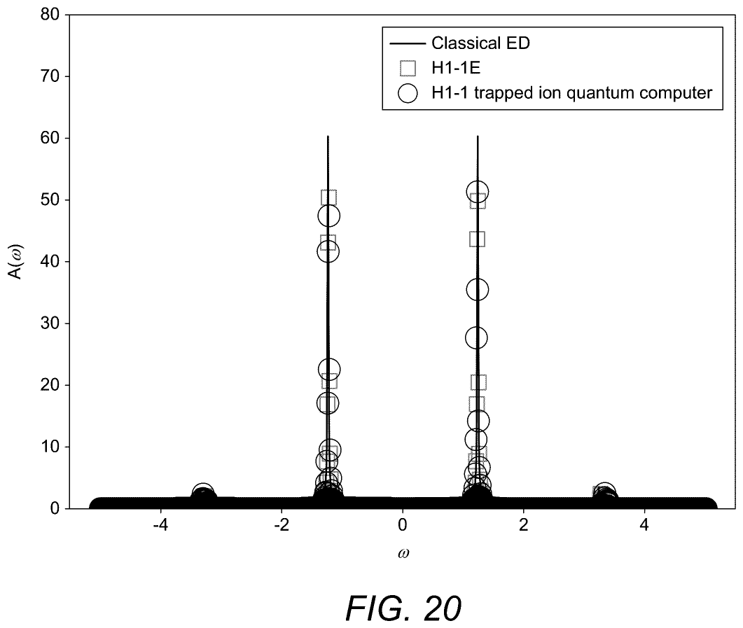

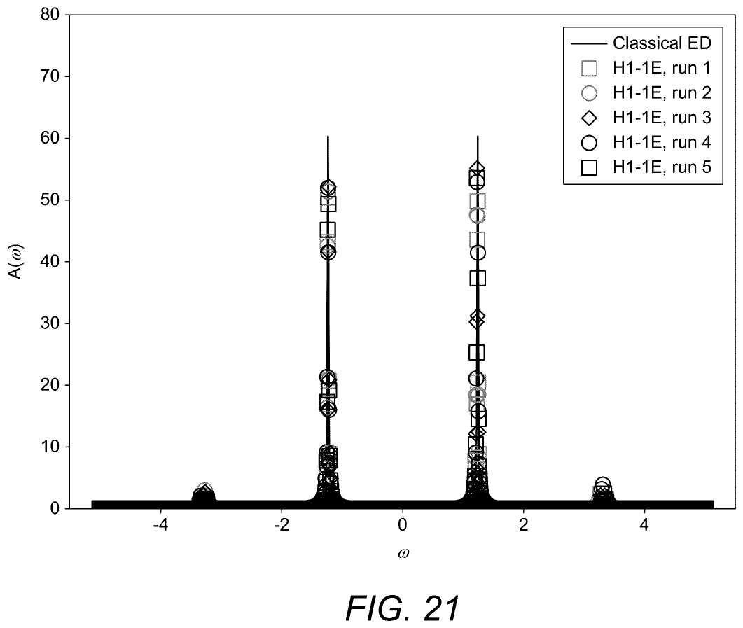

In FIG. 20, the spectral function of the Hubbard dimer is obtained from the Quantinuum H1-1 trapped ion quantum computer, and the Quantinuum H1-1 emulator (H1-1E), with its noise model calibrated to the noise profile of H1-1. The solid line shows the result from classical exact diagonalization (ED). Both the particle and hole GF matrices contain 16 elements, which immediately reduces to 10 elements each due to symmetry about the diagonal. This would naively result in 20 measurable circuits for the full GF: one circuit per matrix element for particle and hole matrices (despite particle-hole symmetry, we explicitly calculate both the particle and hole matrices to more comprehensively test the performance on hardware). Due to certain elements within the particle and hole GF matrices being identical for the Hubbard dimer in this regime, the final total number of measurable circuits for the Hubbard dimer is 14. The total number of (2-qubit ZZ) gates per circuit ranges from 23 to 27 (7 to 9), with depth ranging from 13 to 18. Measurements of each circuit are performed with 8192 shots. Excellent agreement is observed in the spectral peak positions, indicating an accurate description of the excitation energies involved in the particle/hole transitions, when compared to the ideal classical simulation. This is consistent with recent investigations into the robustness of this method to quantum measurement noise and device errors for infimum estimates of the ground state energy, our results indicate a similar robustness for low lying excitation energies. The quality of the results is also indicative of low device errors on the H1-1 trapped ion quantum computer, since measurements of Hamiltonian moment expectations were performed without error mitigation. We also note the excellent agreement between H1-1 and its emulator, which is relevant for later sections involving larger models with circuits too deep for real hardware. FIG. 21 shows the quantum computed GF obtained from the classical emulator of the H1-1 trapped ion quantum computer, with a noise model calibrated to current hardware data. The solid line shows the result from classical ED.

The heights of the two central peaks in FIG. 20 are underestimated by an average (between positive and negative peaks) of ˜18% (17%) for H1-1 (H1-1E). Repeated runs on the emulator H1-1E shows this is roughly consistent (FIG. 21), yielding a mean underestimation of 15% over the 5 runs with a standard deviation of approximately 2.5%. As discussed in section 3.1.1, quantum noise resulting from Hamiltonian moment evaluation affects the normalisation of Lanczos vectors via errors in § 1 Lanczos coefficients, which can translate to erroneous spectral peak heights. However, these errors are not large enough to qualitatively affect the spectral function; the dominance of weight in low lying peaks over higher lying excitations is maintained even in the presence of quantum noise and errors present in the H1-1 trapped ion machine.

Hence, while accurate in the position of low energy peaks, the GF obtained from quantum computed moments present small quantitative errors. Whether these errors are large enough to prevent application of this quantum GF approach to more elaborate simulations, such as quantum embedding within DMFT, remains an interesting question. In the next section, we address this issue and demonstrate the usefulness of this technique for DMFT.

### 3.2.2 DMFT

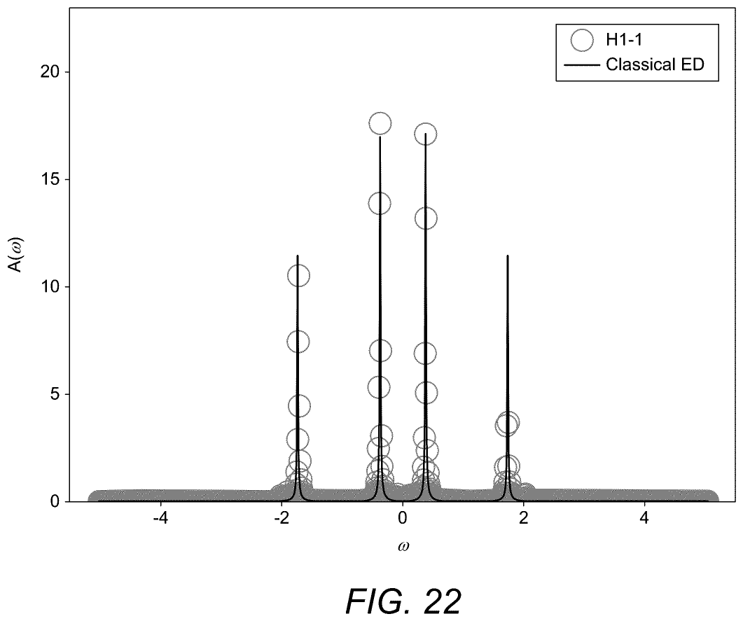

The quantum computed moments approach is also used to obtain the GF of the impurity site in a DMFT algorithm. FIG. 22 shows the quantum computed impurity GF, in which the H1-1 trapped ion quantum computer is used to compute the impurity GF at the final DMFT iteration, following classical impurity GF computations for the previous iterations. The solid line shows the final impurity GF obtained from classical ED. In FIG. 22, the impurity GF corresponding to 1 bath site is quantum computed at the final DMFT step in which the Hamiltonian corresponds to converged bath parameters (where convergence was obtained using ideal noiseless simulations of the quantum GF for previous iterations), using measurements of expectations of Hamiltonian moments performed on the H1-1 trapped ion quantum computer (real and emulated hardware). In this case 2 Lanczos roots were used, which reproduces exact diagonalization (consistent with the Hubbard dimer). For 1 bath site, in each DMFT iteration in which the GF is obtain from the quantum circuit, 14 circuits were measured (corresponding to 14 impurity+bath GF matrix elements, similar to the Hubbard dimer), ranging from 58 (22) to 67 (25) gates (2-qubit gates), with depths ranging from 44 to 51. Each circuit is measured with 8192 shots. The larger number of gates compared to the Hubbard dimer is a result of the reduced symmetry of the impurity-bath Hamiltonian for DMFT. Excellent agreement is observed between the emulator results and the impurity GF obtained from noiseless simulations.

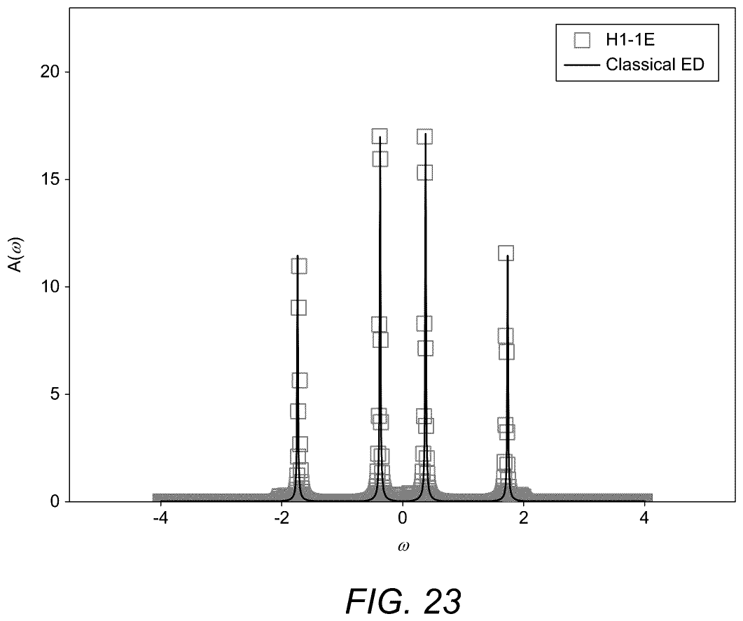

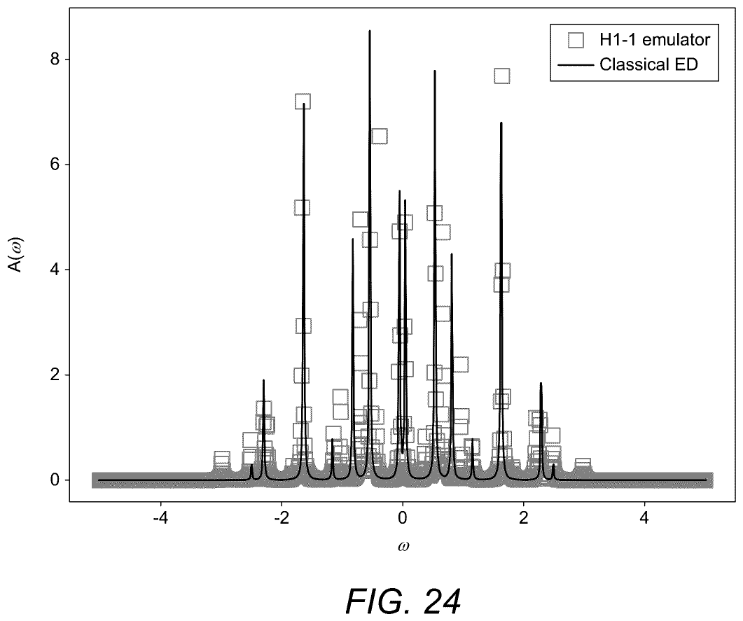

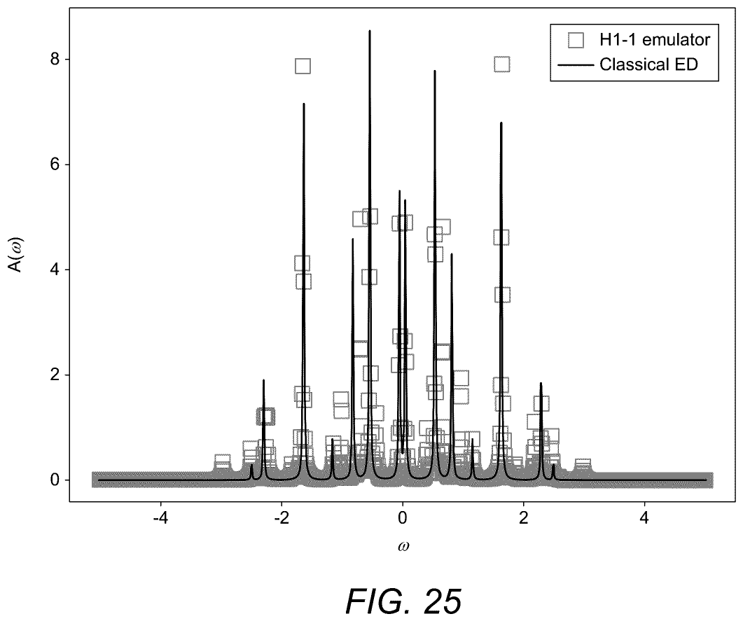

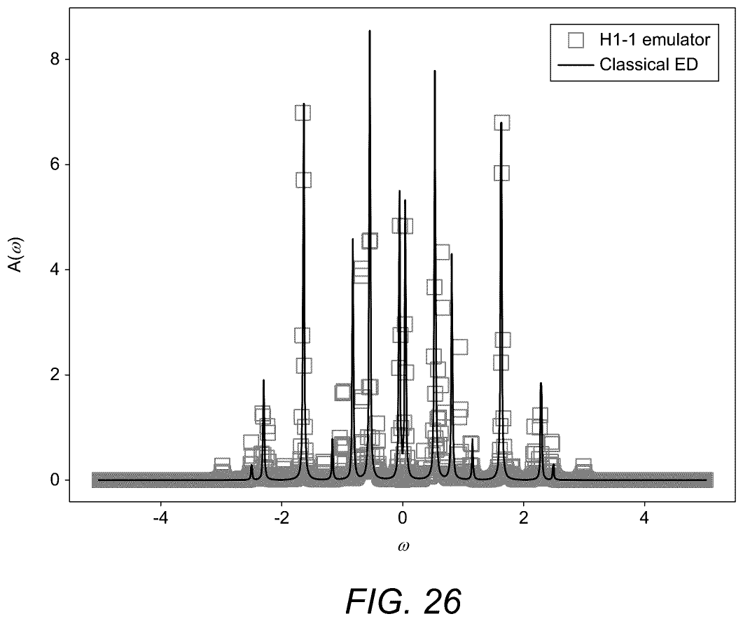

As a step further, a hardware emulator in which the noise model is calibrated to H1-1 was also used to quantum compute the GF at each iteration of DMFT, for 20 iterations. The resulting spectral function is shown in FIG. 23. In particular, FIG. 23 shows the quantum computed impurity GF after 20 DMFT iterations, in which the emulator of the H1-1 trapped ion quantum computer is used to compute the impurity GF at each iteration. The solid line shows the final impurity GF obtained from classical ED. We observe the error in 4° F. is approximately 0.000237, a value sufficiently low enough to obtain a reasonably accurate solution to the impurity problem. Hence the error due to quantum noise from the H1-1 emulator was sufficiently low to run the DMFT algorithm applied to 1 impurity site and 1 bath site for multiple iterations. We also compute the impurity GF corresponding to converged bath parameters for 2 bath sites in the DMFT algorithm, in which 8 Lanczos roots are calculated. This is estimated to be reasonably accurate for 2 and 3 bath sites, in accordance with FIG. 9 in which it was shown that 8 Lanczos roots provide a good approximation to exact diagonalisation for 4 Hubbard sites. In this case 65 circuits were measured (emulated hardware) at the final DMFT iteration to obtain the impurity+bath GF, ranging from 193 (81) to 204 (86) total gates (2-qubit gates), with depths of 212 to 214. The spectral function is shown in FIGS. 24-26. In this case 3 separate applications of the quantum method are applied to the emulator H1-1E, in order to simulate 3 separate hardware runs and assess the variation of results. In particular, FIGS. 24-26 show results for an example quantum computed impurity GF of DMFT with 1 impurity and 2 bath sites, in which the H1-1 trapped ion quantum computer is used to compute the impurity GF at the final DMFT iteration, following classical impurity GF computations for the previous iterations. The solid line shows the final impurity GF obtained from classical ED. We observe that the positions of low-lying spectral peaks generally agree well with the exact result and are also stable against statistical variations in measurements. Higher lying spectral peaks differ in position from the exact result more significantly, while peak heights (associated with normalisation of Lanczos vectors) are also less accurate and are more sensitive to variations due to measurement statistics.

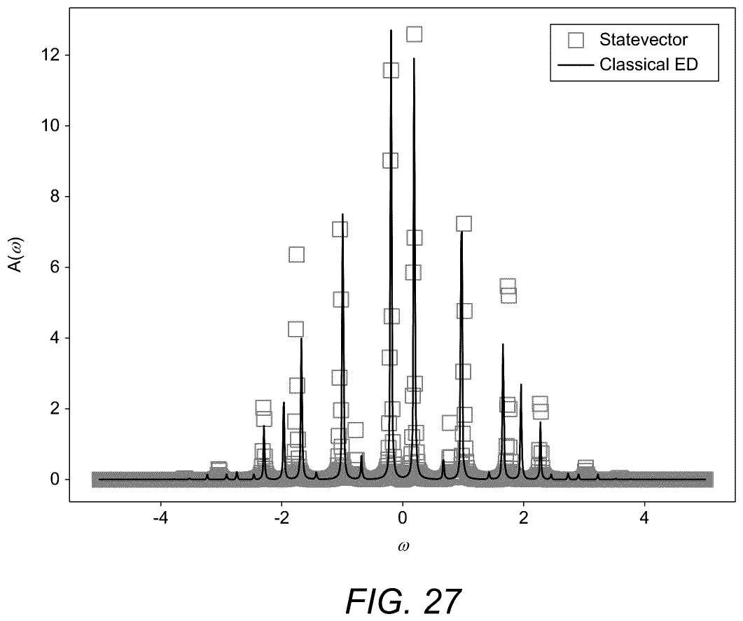

Finally, ideal noiseless simulations, in which the Hamiltonian moment expectations are evaluated classically, are performed for 3 bath sites and the quantum computed moments approach is used to compute the impurity GF at all DMFT iterations. The resulting spectral function is shown in FIG. 27. In particular, FIG. 27 shows results for an example quantum computed impurity GF corresponding to 3 bath sites, calculated to full convergence of the DMFT algorithm. Hamiltonian moment expectation values correspond to ideal noiseless calculations, yielding a corresponding noiseless GF. The solid line represents classical ED.

Disagreements arise in the total number of spectral peaks, and in the weight of low energy poles (consistent with observations made for the spectral function of the 4-site Hubbard model, see section 3.1 and FIG. 9). In this case, disagreements with classical ED are due to the continued fraction representation of the GF in Lanczos method; The Lehmann representation of the GF used in the classical ED is exact for all temperatures T including the limit T→0, this is not the case for the Lanczos calculated GF. In the latter, the exponential factor containing the inverse temperature β is discarded. Hence, despite the common practice, it is strictly an approximation to use a finite β in the fitting of the Lanczos-calculated impurity GF. However, this practice is justified by the common observation that the discrepancies between the Lanczos and ED impurity GFs vanish at sufficiently high β (sufficiently low T). We note that full DMFT convergence is achieved for the quantum Lanczos computed impurity GF, as well as for the classical ED GF, hence the DMFT algorithm finds slightly different solutions corresponding to the differences arising from approximations in the Lanczos computed GF. We choose a relatively low value of β for quicker convergence of the impurity GF, however we expect the differences between Lanczos and ED impurity GFs to vanish as β→∞. Hence, the discrepancies here are not due to errors from quantum noise or measurements, and these results show that this quantum approach in principle works for multiple bath sites in DMFT.

### 4. System Architecture and Implementation

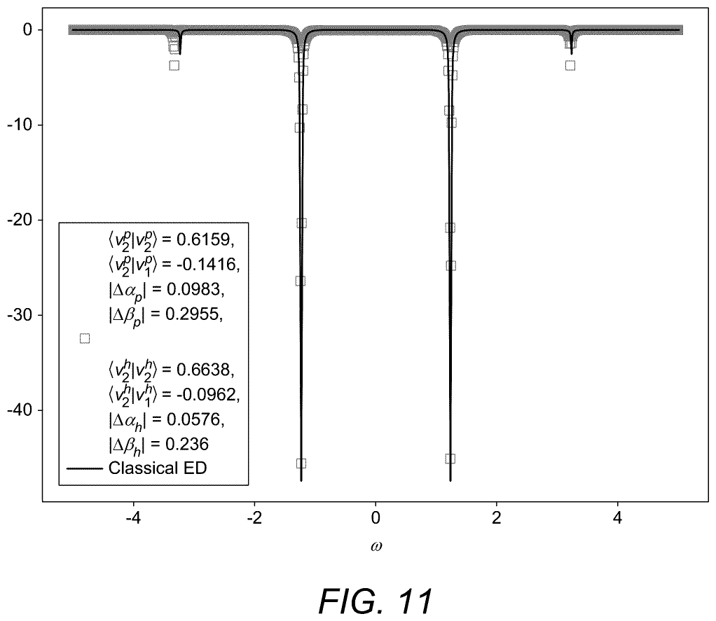

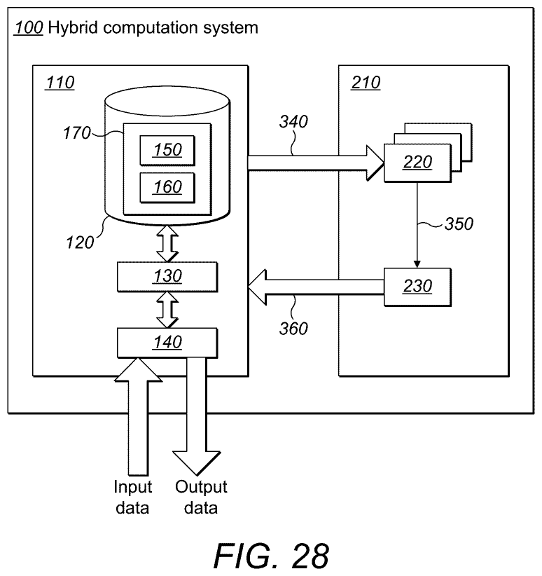

FIG. 28 is a schematic representation of a hybrid quantum computation system 100 including a classical digital computing apparatus 110 and a quantum computing apparatus 210. A sequence of operations to be performed on this system is shown in FIG. 11. Each of the classical computing system 110 and the quantum computing system 210 may comprise one or more computing devices. The classical computer system 110 includes non-volatile data storage 120, at least one volatile memory 130 and at least one processor 140. A quantum circuit builder 150 and a quantum system controller 160 are implemented as modules of a computer program product 170 stored within the non-volatile storage 120 and executable by the processor 140 to generate quantum circuits and to control interactions with a quantum computer to calculate a Green's Function according to embodiments of the concepts, techniques, and structures disclosed herein. The computer program product 170 may also include a state preparation circuit for establishing an initial state of a quantum system that is represented by a computer-readable representation. The computer program product 170 includes control software 160 for transferring 350 a set of generated quantum circuits 220 to the quantum computing system for execution. In particular, the quantum circuit builder 150 and quantum system controller 160 cooperate to implement the method steps of generating quantum circuits and controlling their execution using physical qubits or qudits of the quantum computer 210, and then further processing of the quantum circuit calculations is carried out on the classical computer system as described below.

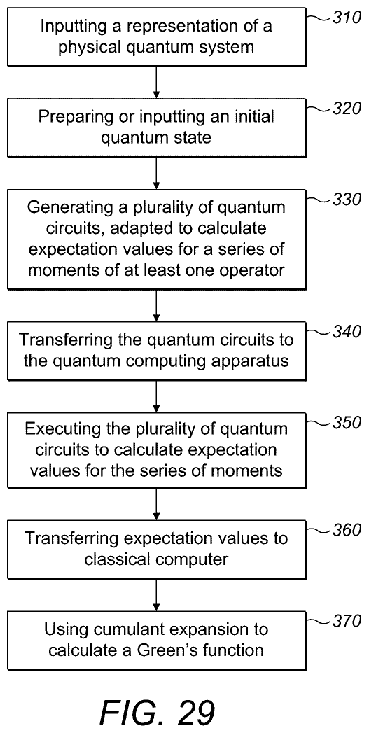

FIG. 29 shows the steps of an example method for calculating the Green's Function within a hybrid quantum computation system such as shown in FIG. 28. The method involves providing 310 a representation of a physical quantum system as input data to a quantum computation system 100. The representation of the physical quantum system includes at least one operator to perform a function with respect to a quantum state of the physical quantum system. An initial state of the physical quantum system may also be provided as an input to the system 100 or may be prepared 320 by a state preparation circuit 150 of the program product 170 within the classical computer system 110. The circuit builder 150 then generates 330 a plurality of quantum circuits 220 from the representation of the physical quantum system, which quantum circuits are adapted to calculate expectation values for a series of moments of at least one operator. The quantum system controller 160 then transfers 340 the generated quantum circuits 220 to the quantum computer system 210, which maps their logical qubits onto physical qubits and executes 350 the plurality of quantum circuits 220 by manipulating the physical qubits to calculate expectation values 230 for the series of moments of the at least one operator. The expectation values are output 360 to the classical computer system which performs a cumulant expansion 370 to calculate a Green's Function from the calculated values, for the series of moments, to determine one or more properties of the physical quantum system.

### 5 Conclusions

In this disclosure, a quantum computational approach has been presented to calculate the single particle Green's function in a spin orbital basis, for example using a cumulant expansion of the Lanczos procedure involving quantum computed moments. This extends beyond recent work which presented the quantum computed moments approach to obtain infimum estimates of the ground state energy. The spin orbital basis is useful in quantum chemistry and quantum physics to describe the electronic structure of atoms, molecules and materials, in a computationally efficient manner. In the described method, we utilize quantum computed moments to obtain the Lanczos coefficients, which in turn can be used to obtain the Green's function in the continued fraction representation.

The described solution allows for multiple strategies to initialise and run the Lanczos procedure. Two separate strategies are described above, one involving the explicit preparation of the first Lanczos vector on a quantum circuit (strategy i)), the other involving measurements of Pauli terms representing the Hamiltonian moments sandwiched between ladder operators indexed by the corresponding Green's function matrix element (strategy ii)). While strategy i) allows for a flexibility in the choice of representation of the Lanczos vector, strategy ii) is advantageous for application of the method on trapped ion quantum computers due to the “NISQ-friendly” number of measurable Pauli terms for small sized Hubbard models.

Using the described approach, we used the Quantinuum H1-1 trapped ion quantum computer to compute the GF matrix of the Hubbard dimer, showing excellent agreement with the ideal noiseless result in terms of spectral peak positions. There is good agreement between the H1-1 quantum computer and the H1-1 emulator (H1-1E) in FIG. 20, which also indicates the accurate approximation of hardware results when applying the emulator to larger models in section 2.3 above. Following the GF of the Hubbard Hamiltonian, the described approach has been applied to obtain the impurity GF in a DMFT algorithm with up to 3 bath sites. Hardware results again show good agreement with the ideal noiseless result when applied to the final DMFT iteration, and emulated hardware results indicate that errors in the GF due to quantum noise do not prevent convergence of the DMFT algorithm when the quantum computed GF is applied to all DMFT iterations. No error mitigation was required to obtain the hardware or emulator results described in this disclosure, but error mitigation techniques may be used in combination with the described methods and systems.

A study was performed of the scaling of the number of measurable Pauli terms with respect to the Hamiltonian moment index, for the sandwiched moment operators required for strategy ii), indicating polynomial scaling and a saturation for high-lying moments. An investigation of errors in the Lanczos basis and corresponding coefficients arising from quantum noise provided an indication of how these can impact elements of the GF matrix. As mentioned in section 3.1.1, an accurate description of the relation between quantum noise and errors in the Lanczos basis enables the development of techniques to correct for these errors. For example, knowledge of this relation can be used to design error mitigation protocols in which noisy measurements of Hamiltonian moments, or the resulting errors in the Lanczos coefficients, are corrected/mitigated by known calibration data of a particular device. This has the potential to widen the application domain of quantum computed Green's functions by allowing for larger system sizes, represented by larger, more error prone circuits.

In illustrative implementations of the concepts described herein, one or more computers (e.g., integrated circuits, microcontrollers, controllers, microprocessors, processors, field-programmable-gate arrays, personal computers, onboard computers, remote computers, servers, network hosts, or client computers) may be programmed and specially adapted: (1) to perform any computation, calculation, program or algorithm described or implied above; (2) to receive signals indicative of human input; (3) to output signals for controlling transducers for outputting information in human perceivable format; (4) to process data, to perform computations, to execute any algorithm or software, and (5) to control the read or write of data to and from memory devices. The one or more computers may be connected to each other or to other components in the system either: (a) wirelessly, (b) by wired or fiber optic connection, or (c) by any combination of wired, fiber optic or wireless connections.

In illustrative implementations of the concepts described herein, one or more computers may be programmed to perform any and all computations, calculations, programs and algorithms described or implied above using computer program code, and any and all functions described in the immediately preceding paragraph. Likewise, in illustrative implementations of the concepts described herein, one or more non-transitory, machine-accessible media may have instructions encoded thereon for one or more computers to perform any and all computations, calculations, programs and algorithms described or implied above, and any and all functions described in the immediately preceding paragraph.

For example, in some cases: (a) a machine-accessible medium may have instructions encoded thereon that specify steps in a software program; and (b) the computer may access the instructions encoded on the machine-accessible medium, in order to determine steps to execute in the software program. In illustrative implementations, the machine-accessible medium may comprise a tangible non-transitory medium. In some cases, the machine-accessible medium may comprise (a) a memory unit or (b) an auxiliary memory storage device. For example, in some cases, while a program is executing, a control unit in a computer may fetch the next coded instruction from memory.

In some cases, one or more computers are programmed for communication over a network. For example, in some cases, one or more computers are programmed for network communication: (a) in accordance with the Internet Protocol Suite, or (b) in accordance with any other industry standard for communication, including any USB standard, ethernet standard (e.g., IEEE 802.3), token ring standard (e.g., IEEE 802.5), or wireless communication standard, including IEEE 802.11 (Wi-Fi®), IEEE 802.15 (Bluetooth®/Zigbee®), IEEE 802.16, IEEE 802.20, GSM (global system for mobile communications), UMTS (universal mobile telecommunication system), CDMA (code division multiple access, including IS-95, IS-2000, and WCDMA), LTE (long term evolution), or 5G (e.g., ITU IMT-2020).

As used herein, “including” means including without limitation. As used herein, the terms “a” and “an”, when modifying a noun, do not imply that only one of the noun exists. As used herein, unless the context clearly indicates otherwise, “or” means and/or. For example, A or B is true if A is true, or B is true, or both A and B are true. As used herein, “for example”, “for instance”, “e.g.”, and “such as” refer to non-limiting examples that are not exclusive examples. The word “consists” (and variants thereof) are to be give the same meaning as the word “comprises” or “includes” (or variants thereof).

The above description (including any attached drawings and figures) illustrates example implementations of the concepts described herein. However, the concepts described herein may be implemented in other ways. The methods and apparatus which are described above are merely illustrative applications of the principles of the described concepts. Numerous modifications may be made by those skilled in the art without departing from the scope of the concepts, techniques, and structures disclosed herein. Also, the described concepts include without limitation each combination, sub-combination, and permutation of one or more of the abovementioned implementations, embodiments and features.

Various embodiments of the concepts, systems, devices, structures and techniques sought to be protected are described herein with reference to the related drawings. Alternative embodiments can be devised without departing from the scope of the concepts, systems, devices, structures and techniques described herein. It is noted that various connections and positional relationships (e.g., over, below, adjacent, etc.) are set forth between elements in the following description and in the drawings. These connections and/or positional relationships, unless specified otherwise, can be direct or indirect, and the described concepts, systems, devices, structures and techniques are not intended to be limiting in this respect. Accordingly, a coupling of entities can refer to either a direct or an indirect coupling, and a positional relationship between entities can be a direct or indirect positional relationship.

As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s). The following definitions and abbreviations are to be used for the interpretation of the specification. As used herein, the terms “comprises,” “comprising, “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance, or illustration. Any embodiment or design described herein as “exemplary” is not necessarily to be construed as preferred or advantageous over other embodiments or designs. The terms “one or more” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

References in the specification to “one embodiment, “an embodiment,” “an example embodiment,” etc., indicate that the embodiment described can include a particular feature, structure, or characteristic, but every embodiment can include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal, “top,” “bottom,” and derivatives thereof shall relate to the described structures and methods, as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary elements.

Use of ordinal terms such as “first,” “second,” “third,” etc., in the specification to modify an element does not by itself connote any priority, precedence, or order of one element over another or the temporal order in which acts of a method are performed, but are used merely as labels to distinguish one element having a certain name from another element having a same name (but for use of the ordinal term) to distinguish the elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter.

Accordingly, although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

We claim:

1. A computer-implemented quantum computation method comprising:
providing a representation of a physical quantum system as an input to a quantum computation system, the representation of the physical quantum system including at least one operator to perform a function with respect to a quantum state of the physical quantum system;
generating a plurality of quantum circuits from the representation of the physical quantum system, which quantum circuits are adapted to calculate expectation values for a series of moments of the at least one operator;
executing the plurality of quantum circuits to calculate expectation values for the series of moments of the at least one operator; and
using cumulant expansion, calculating a Green's Function from the calculated values for the series of moments to determine one or more properties of the physical quantum system.

2. A computer-implemented method according to claim 1, wherein the quantum computation system comprises a classical digital computing apparatus coupled to a quantum computer, wherein the generating of quantum circuits is performed on the classical digital computing apparatus and the executing of the quantum circuits is performed on the quantum computer, and the calculating of the Green's Function is performed on the classical digital computing apparatus.

3. A computer-implemented method according to claim 1, wherein the provided representation of the physical quantum system comprises a Hamiltonian including at least one excitation operator representing a dynamic response of the physical quantum system to internal particle or spin interactions or external perturbations.

4. A computer-implemented method according to claim 1, wherein the provided representation of the physical quantum system comprises a Hamiltonian including at least one excitation operator representing quantum energy state transitions of the physical quantum system.

5. A computer-implemented method according to claim 4, wherein providing the representation of the physical system comprises inputting a ground energy state of the physical quantum system.

6. A computer-implemented method according to claim 1, comprising using a state preparation circuit to provide an initial quantum state of the physical quantum system, and calculating expectation values for a set of moments of the at least one operator with respect to this circuit.

7. A computer-implemented method according to claim 1, comprising calculating expectation values for a set of moments of the at least one operator by sandwiching a moment of a Hamiltonian operator with ladder operators or sums of ladder operators, indexed according to an initial quantum state of the physical quantum system.

8. A computer-implemented method according to claim 1, wherein a Green's Function is used to calculate a dynamic response of the physical quantum system to one or more external perturbations.

9. A computer-implemented method according to claim 1, wherein a Green's Function is used to calculate spectroscopic properties of the physical quantum system.

10. A computer-implemented method according to claim 1, wherein a Green's Function is used to calculate conductivity of a material.

11. A computer-implemented method according to claim 1, wherein cumulants are derived from the expectation values calculated by execution of the quantum circuits, and the cumulant expansion generates elements of a diagonal matrix that is suitable for processing by a classical digital computer apparatus.

12. A computer-implemented method according to claim 11, wherein the cumulants are Lanczos coefficients and the moments of the at least one operator correspond to moments of at least one operator applied to an initial Lanczos vector.

13. A computer-implemented method according to claim 1, wherein the quantum computation system comprises a classical digital computing apparatus coupled with a classical emulation of a quantum computer, wherein the executing of the quantum circuits is performed on the classical emulation of quantum computer.

14. A computer program product comprising computer program code recorded on a storage medium and adapted for execution by a quantum computation system to control the quantum computation system to perform a method comprising:
providing a representation of a physical quantum system as an input to a quantum computation system, the representation of the physical quantum system including at least one operator to perform a function with respect to a quantum state of the physical quantum system;
generating a plurality of quantum circuits from the representation of the physical quantum system, which quantum circuits are adapted to calculate expectation values for a series of moments of the at least one operator;
executing the plurality of quantum circuits to calculate expectation values for the series of moments of the at least one operator; and
using cumulant expansion, calculating a Green's Function from the calculated values for the series of moments to determine one or more properties of the physical quantum system.

15. A computer program product according to claim 14, for execution by a quantum computation system comprising a classical digital computing apparatus coupled to a quantum computing apparatus, wherein the computer program code comprises:
a quantum circuit builder component for configuring the classical digital computing apparatus to generate a plurality of quantum circuits for calculating expectation values for a series of moments of the at least one operator; and
a controller component for controlling execution of the plurality of quantum circuits on qubits or qudits of the quantum computing apparatus to calculate expectation values for the series of moments of the at least one operator, and for controlling performance of a cumulant expansion based on the calculated expectation values for the series of moments to calculate the Green's Function.

16. A quantum computation system comprising:
a classical digital computing apparatus that is configured to receive an input representation of a physical quantum system, the representation of the physical quantum system including at least one operator to perform a function with respect to a quantum state of the physical quantum system, and is configured to generate a plurality of quantum circuits from the representation of the physical quantum system, which quantum circuits are adapted to calculate expectation values for a series of moments of the at least one operator; and
a quantum computing apparatus, coupled to the classical digital computing apparatus, which quantum computing apparatus is configured to execute the plurality of quantum circuits to calculate expectation values for the series of moments of the at least one operator;
wherein the quantum computation system is also configured to perform a cumulant expansion based on the calculated expectation values for the series of moments, to calculate a Green's Function to determine one or more properties of the physical quantum system.
